(19) United States
(12) Patent Application Publication
(10) Pub. No.: US 2026/0291805 A1
(43) Pub. Date: Sep. 24, 2026

(54) SYSTEM

(71) Applicant: SoftBank Group Corp., Tokyo (JP)

(72) Inventor: Amane ORITO, Tokyo (JP)

(73) Assignee: SoftBank Group Corp., Tokyo (JP)

(21) Appl. No.: 19/562,871

(22) Filed: Mar. 11, 2026

(30) Foreign Application Priority Data
Mar. 19, 2025 (JP) 2025-044966

(51) Int. Cl. H04L 41/0663; H04L 41/147; H04L 41/16; H04L 43/08

(52) U.S. Cl. CPC H04L 41/0663; H04L 41/147; H04L 41/16; H04L 43/08

(57) ABSTRACT

A system includes a processor that is configured to: collect location information of mobile terminals and analyze the collected location information to predict network demand, input a demand prediction result as a prompt to a generative artificial intelligence model in order to instruct automatic execution of an optimal network configuration according to time and location, and monitor an operating status of base stations by using sensors and monitoring software and, when an abnormality is detected, activate an automatic repair module to perform repair.

### CROSS-REFERENCE TO RELATED APPLICATION

This application is based on and claims priority under 35 USC 119 from Japanese Patent Application No. 2025-044966 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional mobile communication networks are typically configured based on static or coarse-grained planning that does not sufficiently take into account fine-grained temporal and spatial fluctuations in user distribution and traffic demand. As a result, during peak periods or localized events, excessive congestion and degradation of quality of service may occur in specific areas, while other areas remain underutilized. In addition, in many existing systems, the configuration of network parameters in response to demand predictions is performed manually or by using rigid rule-based logic, which limits responsiveness and adaptability, particularly in complex and rapidly changing environments. Furthermore, monitoring and maintenance of base stations are often dependent on manual operations or simple threshold-based alarms, which may delay detection and recovery from faults, thereby increasing service downtime and adversely affecting users.

In view of the foregoing, there is a need for a system that can: (i) accurately predict network demand by analyzing location information of mobile terminals, (ii) utilize a generative artificial intelligence model to derive and apply optimal network configurations automatically in accordance with time and location, and (iii) continuously monitor the operating status of base stations and automatically initiate repair actions upon detection of abnormalities, so as to improve network efficiency, service quality, and fault resilience.

### SUMMARY

In order to solve the above-described problems, a system is provided that comprises a processor configured to perform a series of coordinated functions. The processor is configured to collect location information of mobile terminals, such as GPS data or other positioning information, and to analyze the collected location information to predict network demand for respective areas and time periods. The processor is further configured to input a demand prediction result as a prompt to a generative artificial intelligence model, so that the generative artificial intelligence model outputs instructions for automatically executing an optimal network configuration according to time and location, and the processor controls the network in accordance with the instructions. In addition, the processor is configured to monitor an operating status of base stations by using sensors and monitoring software, detect abnormalities in the operating status based on the monitoring, and, when an abnormality is detected, activate an automatic repair module to perform repair, including at least one of restarting a base station and adjusting network parameters of neighboring base stations. By integrating demand prediction based on mobile terminal location information, AI-driven configuration control, and automatic fault detection and repair, the system enables dynamic optimization and robust operation of the communication network.

The term “system” refers to an apparatus or combination of apparatuses including at least one processor and, optionally, memory, communication interfaces, sensors, base stations, and software modules that cooperate to perform the claimed functions.

The term “processor” refers to any hardware device or combination of hardware devices capable of executing instructions, such as a central processing unit (CPU), a microprocessor, a digital signal processor (DSP), a microcontroller, or a programmable logic device, including equivalents and multiple cooperating processors.

The term “mobile terminal” refers to any user equipment or communication device that is capable of wireless communication with a network, including but not limited to smartphones, tablets, laptops with wireless capability, wearable devices, vehicular communication units, and Internet of Things (IoT) devices.

The term “location information” refers to data indicating a geographical position of a mobile terminal, including but not limited to GPS coordinates, cell-ID-based positions, Wi-Fi-based positions, or any other information enabling determination or approximation of a physical location.

The term “network demand” refers to a quantity or level of expected or actual usage of network resources in a communication network, including but not limited to data traffic volume, number of active terminals, required bandwidth, or quality of service requirements within a given area and time period.

The term “demand prediction result” refers to information generated by analysis of collected location information and optionally other data, indicating a predicted network demand for one or more areas and time periods, and including at least one of a traffic volume, a congestion level, or a resource requirement.

The term “generative artificial intelligence model” refers to a machine learning model that is capable of generating outputs, such as text, configuration plans, or parameter sets, based on input data or prompts, including but not limited to large language models, transformer-based models, generative adversarial networks, or other generative architectures.

The term “prompt” refers to input data, including textual, numerical, or structured information, supplied to a generative artificial intelligence model to condition or guide the generation of an output, in this case comprising at least a demand prediction result.

The term “optimal network configuration” refers to a set of network parameters or control actions that are determined to improve or optimize one or more performance metrics of a communication network, such as throughput, latency, reliability, energy efficiency, or load balance, under given constraints and for specific times and locations.

The term “time and location” refers to temporal and spatial conditions under which the network configuration is determined or applied, including specific time points or periods and specific geographic areas or base station coverage regions.

The term “base station” refers to any network node that provides wireless communication coverage to one or more mobile terminals, including but not limited to cellular base stations, eNodeBs, gNodeBs, small cells, or equivalent radio access nodes.

The term “operating status of base stations” refers to information representing operational conditions of base stations, including but not limited to activity state, availability, load, error states, performance indicators, and connectivity status.

The term “sensor” refers to a hardware component or device that detects or measures a physical, electrical, or logical condition related to a base station or its environment, such as temperature, power level, signal strength, or hardware status.

The term “monitoring software” refers to software components, including agents, services, or applications, that collect, analyze, or report status information regarding base stations, network elements, or sensors, and that support detection of abnormalities.

The term “abnormality” refers to any deviation of the operating status of a base station from a normal or expected range, including but not limited to failures, outages, excessive error rates, missing heartbeat messages, performance degradation, or configuration inconsistencies.

The term “automatic repair module” refers to a hardware and/or software component that, upon activation, performs repair or mitigation actions without human intervention, such actions including at least one of restarting a base station, reloading configuration, or reconfiguring neighboring network elements.

The term “repair” refers to any action taken to restore or at least partially restore normal or acceptable operation of a base station or the network, including but not limited to restarting equipment, resetting or updating software, adjusting network parameters, or activating redundancy mechanisms.

The term “automatic execution” refers to execution of operations or application of configurations by the system without requiring manual intervention by an operator at the time of execution, based on predefined logic, models, or instructions generated by the processor or the generative artificial intelligence model.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

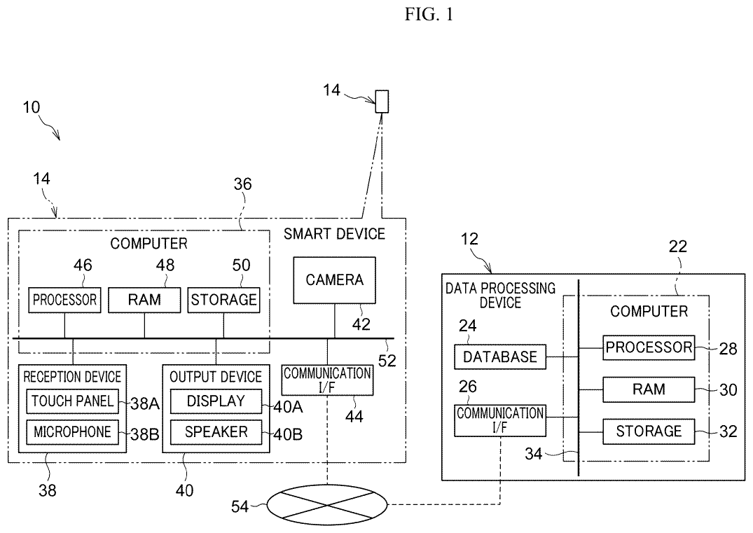

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

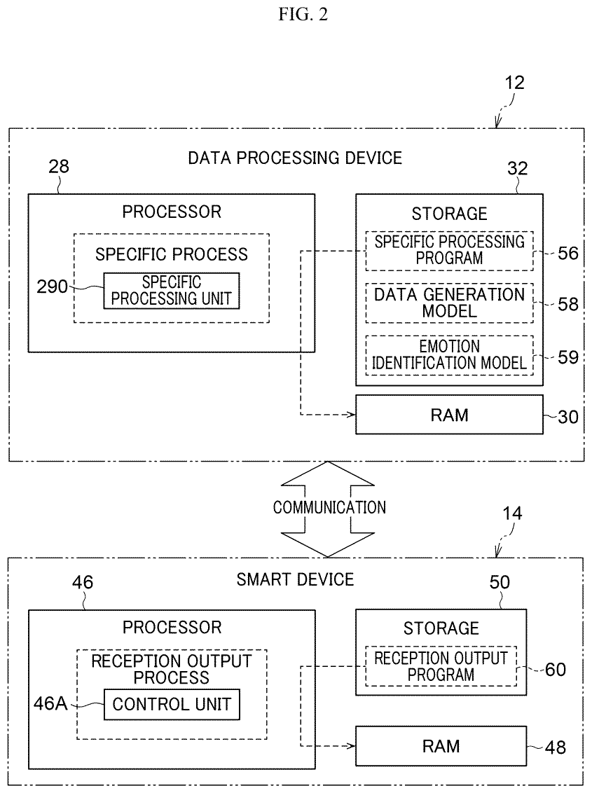

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional communication network management systems rely heavily on static rules, manual configuration, and separately implemented prediction algorithms. In such systems, a processor typically processes raw telemetry and performance counters to produce coarse demand estimations, while a human operator or a rule-based engine manually derives configuration changes from those estimations. This separation between demand prediction and configuration control leads to multiple technical problems in computer-implemented network management. First, conventional systems process location information and network usage information in a fragmented manner. Position information of mobile bodies, historical traffic information, and event information are often stored in disparate data stores and accessed by separate applications. As a result, the processor cannot efficiently generate integrated demand prediction data aligned in time and space. This causes duplicated data processing, increased memory transfers between processes, and overhead from repeated queries, which degrade the overall performance and scalability of the computer system executing the network management functions. Second, conventional systems cannot effectively exploit generative artificial intelligence models because they lack a structured and adaptive mechanism for constructing prompt sentences and feeding them to such models together with machine-readable prediction data. In existing approaches, natural language prompts are often manually designed, static, and disconnected from real-time telemetry and historical error information. Because of this, the processor does not utilize the full modeling capability of generative artificial intelligence models, leading to suboptimal or unstable configuration recommendations, and requiring further human interpretation and adjustment. This increases processing latency, consumes additional computational resources for post-processing and overrides, and limits automation.

Third, conventional automatic remediation mechanisms for communication apparatuses are typically based on pre-defined fault signatures and scripts. The processor detects an abnormality by monitoring sensors and log files, but then executes a fixed, static repair sequence that does not take into account the current network topology, recent configuration history, or learned patterns from past incidents. This rigidity leads to failures in selecting an appropriate repair step, unnecessary reboots, and repeated application of ineffective scripts. As these scripts are not generated or adapted using an intelligent model, the system must maintain a large set of hard-coded rules, increasing complexity, memory usage, and maintenance costs. Furthermore, misalignment between the fault detection logic and the repair scripts can cause inconsistent states in the communication apparatuses.

Fourth, conventional systems do not close the loop between prediction, configuration, and feedback in a way that improves the computational behavior of the system over time. Demand prediction errors and the effectiveness of configuration plans are not systematically fed back into the prediction and decision-making pipeline. As a result, the processor repeatedly performs similar computations, without leveraging historical error patterns to refine future input structures or model behavior. This not only leads to persistent prediction inaccuracies, but also causes inefficient resource utilization, such as unnecessarily high safety margins or inadequate capacity in specific areas and time periods, thereby increasing the computational and operational load on the supporting computer systems.

Therefore, there is a need for a computer-implemented technique that integrates multi-source data aggregation, generative artificial intelligence model prompting, configuration generation, and automatic remediation into a unified processing pipeline. Such a technique should improve how a processor structures and uses data to interact with a generative artificial intelligence model, dynamically adapt prompt sentences and configuration plans based on feedback, and thereby improve the efficiency, reliability, and scalability of computer systems that control large-scale communication networks. The problem to be solved by the present invention is to provide a system and method that technically improve computer-based network management by reducing redundant processing, enabling more accurate and adaptive decision making, and enhancing automated recovery behavior through a coordinated, AI-assisted control loop.

The specific processing by the specific processing unit 290 of the data processing device 12 in Example 1 is realized by the following means.

The present invention provides a server comprising a processor and a storage apparatus, the processor being configured to receive position information of mobile bodies from an information acquisition apparatus, aggregate the position information based on time information and area information to generate distribution information of the mobile bodies for each predetermined time interval and spatial unit, obtain from the storage apparatus the distribution information, historical communication amount information, and performance information of communication apparatuses constituting a communication network, associate the distribution information with the communication amount information and the performance information to generate demand prediction data, calculate demand prediction results of the communication network for predetermined times and areas based on the demand prediction data, generate a prompt sentence to be input to a generative artificial intelligence model by using the demand prediction results and event information related to a time range and an area range for which the demand prediction results are calculated, input the prompt sentence and the demand prediction data into the generative artificial intelligence model to cause the generative artificial intelligence model to output a configuration plan including optimal setting contents of the communication network for each time and each area, generate setting information for the communication apparatuses based on the configuration plan, transmit the setting information to the communication apparatuses via a communication management apparatus to automatically change parameters of the communication network and thereby execute resource allocation and quality control, analyze operation state information of the communication apparatuses acquired from detection apparatuses and monitoring programs provided in the communication apparatuses, upon detecting an abnormality of at least one of the communication apparatuses, input into the generative artificial intelligence model a prompt sentence including contents of the abnormality and configuration information of the communication apparatuses to obtain a repair procedure plan, start an automatic repair processing program to automatically execute a repair process including at least one of setting change of the communication apparatuses, restart processing, and route switching processing based on the repair procedure plan, and integrate the demand prediction results, the configuration plan, and an execution status of the repair process, transmit notification information including the integration to a network management terminal, and record the integration as learning data for updating future demand prediction and contents of the prompt sentence. This enables a computer system to implement an integrated control loop in which multi-source telemetry and event data are aggregated into structured prediction data, dynamically constructed prompt sentences are supplied together with the prediction data to a generative artificial intelligence model, network configuration plans and repair procedure plans are automatically derived and applied to communication apparatuses, and feedback on prediction errors and execution results is persisted as learning data, thereby improving the accuracy, efficiency, and adaptability of computer-implemented network management operations.

The term “mobile body” refers to a movable apparatus capable of having or generating position information, including but not limited to portable terminals, vehicles, and other movable communication devices.

The term “position information” refers to information indicating a current or past location of a mobile body, including at least latitude and longitude, and optionally including altitude, time, and identification information.

The term “information acquisition apparatus” refers to a hardware and software combination configured to obtain position information of mobile bodies, such as a terminal device including a positioning sensor and a communication function.

The term “time information” refers to information indicating a point in time or a time interval associated with position information, demand prediction results, or network operation data.

The term “area information” refers to information indicating a spatial region associated with position information or network operation data, such as a cell, a grid, a sector, or a geographical zone.

The term “distribution information” refers to information representing a spatial and temporal distribution of mobile bodies, including, for example, counts or densities of mobile bodies per time interval and spatial unit.

The term “communication apparatus” refers to hardware and software components that constitute a communication network, including but not limited to base stations, switches, routers, gateways, and communication controllers.

The term “communication network” refers to an infrastructure for data communication including a plurality of communication apparatuses, transmission paths, and control systems for providing communication services.

The term “historical communication amount information” refers to stored information indicating past volumes of communication traffic handled by communication apparatuses, such as data throughput, packet counts, or session numbers per time and area.

The term “performance information” refers to information indicating operational performance of communication apparatuses, including, for example, latency, error rate, packet loss, throughput, utilization, and similar metrics.

The term “demand prediction data” refers to information generated by associating distribution information of mobile bodies with historical communication amount information and performance information, which is used as input for calculating demand prediction results.

The term “demand prediction results” refers to information indicating predicted future usage of a communication network for specific times and areas, including at least predicted traffic volume and load level.

The term “event information” refers to information relating to events that may influence communication demand, including at least event type, time range, location, and expected scale.

The term “generative artificial intelligence model” refers to a machine learning model configured to generate outputs such as text or structured data from given inputs, based on learned parameters, including generative models using neural networks.

The term “prompt sentence” refers to a natural language or structured text input supplied to a generative artificial intelligence model, instructing the model to perform a particular task or generate a particular type of output.

The term “configuration plan” refers to information output from a generative artificial intelligence model indicating recommended or optimal settings for a communication network, including at least parameter values per time and area.

The term “setting information” refers to information representing specific configuration values or commands to be applied to communication apparatuses in order to implement a configuration plan.

The term “communication management apparatus” refers to an apparatus or system that manages configuration, control, and monitoring of communication apparatuses, such as a network management system or a control server.

The term “parameter of the communication network” refers to a configurable value or control variable that affects operation of the communication network, such as bandwidth allocation, frequency assignment, priority level, or routing policy.

The term “resource allocation” refers to a process of assigning communication resources, including radio resources, bandwidth, and processing capacity, to different services, users, or areas.

The term “quality control” refers to control of quality of communication service, including adjustment of latency, throughput, packet loss, priority, or other quality-of-service parameters.

The term “detection apparatus” refers to a device or component that acquires operation state information of a communication apparatus, such as a sensor, a monitor, or a telemetry module.

The term “monitoring program” refers to software configured to collect, analyze, or log operation state information of communication apparatuses, including management agents and monitoring processes.

The term “operation state information” refers to information indicating an operational condition of a communication apparatus, including status indicators, alarms, logs, counters, and performance metrics.

The term “abnormality” refers to a state in which an operation of a communication apparatus deviates from a normal range, including failures, faults, performance degradation, or configuration inconsistencies.

The term “configuration information of the communication apparatuses” refers to information indicating current or past configuration parameters, software versions, topology relationships, and similar settings of communication apparatuses.

The term “repair procedure plan” refers to information output from a generative artificial intelligence model describing a sequence of steps to correct an abnormality of communication apparatuses.

The term “automatic repair processing program” refers to software that executes repair steps on communication apparatuses without requiring manual intervention, according to a repair procedure plan.

The term “restart processing” refers to a procedure that restarts a communication apparatus or a function thereof, such as rebooting hardware, restarting a software process, or reinitializing a module.

The term “route switching processing” refers to a procedure that changes a communication path or routing entry in order to bypass a faulty apparatus or congested path.

The term “network management terminal” refers to a terminal apparatus used by a network administrator to view, control, or manage a communication network, such as a workstation, a console, or a client device.

The term “notification information” refers to information transmitted to a network management terminal to report demand prediction results, configuration plans, abnormalities, repair processes, or their execution status.

The term “learning data” refers to information stored for use in training, fine-tuning, or adjusting a model or algorithm, including historical prediction errors, configuration outcomes, and prompt sentence variants.

The server, the terminal, and the user cooperate to implement embodiments of the invention as described below. In each embodiment, the same reference concepts may be used for components having substantially the same functions.

In a typical embodiment, the server is implemented as one or more physical computer machines, such as rack-mounted servers or virtual machines provided by a cloud computing platform. The server includes at least one multi-core central processing unit, main memory, persistent storage, and a network interface. The server executes an operating system such as a general-purpose server operating system and runs application software including a web application framework, a database management system, and a model-serving middleware. The server also cooperates with a generative AI model executed on one or more accelerator devices such as graphic processing units connected to the server via a high-speed interconnect.

The terminal is implemented as a mobile communication device, such as a smartphone, a tablet, or a vehicle-mounted communication unit. The terminal includes a processor, memory, a positioning sensor such as a GPS receiver, and a wireless communication modem capable of cellular communication. The terminal executes an operating system such as a mobile operating system and provides high-level location services and communication libraries to an application program installed on the terminal.

The user is implemented as a human operator who accesses a network management terminal. The network management terminal may be a personal computer, a notebook computer, or another workstation connected to the communication network. The user interacts with a management interface provided by the server through a web browser or a dedicated client application.

In one embodiment, the terminal periodically acquires position information of a mobile body.

The terminal uses its built-in GPS hardware and a location service library of the operating system to obtain latitude, longitude, and time information. The terminal normalizes the position information into a compact internal structure, for example a fixed-length record including numerical fields for latitude, longitude, timestamp, and a terminal identifier. The terminal stores recent samples in local memory and transmits them to the server over a wireless communication link using a secure transport protocol. By pre-normalizing and buffering the data, the terminal reduces transmission overhead and avoids redundant requests, which in turn reduces network load and improves end-to-end latency for position acquisition.

The server receives the position information transmitted from a plurality of terminals. The server stores raw position records in a database, for example a relational database or a distributed storage system, in tables optimized for time-series and spatial queries. The server converts the latitude and longitude values into discrete area identifiers, for example by computing a grid index or a hierarchical spatial code. The server associates each record with a time slot identifier computed from the timestamp, such as a fixed-length interval. By mapping the raw data into a time-area grid, the server creates distribution information that can be processed efficiently by vectorized operations and cached queries, thereby improving processing throughput and reducing memory usage compared with ad-hoc, unstructured storage.

The server aggregates the position information into distribution information of mobile bodies.

The server groups records by area identifier and time slot identifier and computes counts and other statistics such as average speed or direction where needed. The server stores the aggregation results in a separate table or in an in-memory data structure that represents a two-dimensional matrix over time and area. The server uses efficient numerical libraries to compute these aggregates, thereby leveraging cache locality and parallel execution on the server processor. This structured aggregation enables the server to feed compact, information-dense features into subsequent prediction modules, reducing both storage costs and data transfer inside the system.

The server also stores and manages historical communication amount information and performance information obtained from communication apparatuses such as base stations, switches, and routers. The server acquires traffic counters, quality metrics, and error rates from these communication apparatuses using standard management protocols or telemetry streams.

The server associates each performance record with time and area identifiers aligned with those used for the distribution information of mobile bodies. This alignment enables the server to generate demand prediction data where each time-area cell contains a joint representation of user distribution and network performance history.

The server generates the demand prediction data by combining the distribution information, the historical communication amount information, and the performance information. The server forms feature vectors for each time-area cell, including elements such as device count, normalized traffic volume, throughput indicators, latency metrics, and recent trends. The server stores these feature vectors in a structured data set ready for input to a predictive algorithm. The server may also include categorical identifiers of event types or network configurations as additional features. Because the server represents the combined information as fixed-length vectors and aligned matrices, the server can execute efficient batch computations on the data, reducing the number of passes over the storage subsystem and improving computational efficiency.

The server calculates demand prediction results of the communication network using the demand prediction data. In one embodiment, the server employs a prediction model separate from the generative AI model, such as a gradient boosting model, a recurrent neural network, or a convolutional neural network over the time-area grid. The server trains this model offline using historical data and periodically updates its parameters. The server executes the trained model on the demand prediction data to produce predicted values such as future traffic volumes, expected congestion levels, and required capacity margins for each time-area cell. The server stores the demand prediction results as structured records associated with time and area identifiers. By computing numerical predictions in this manner, the server provides a deterministic, low-latency basis for further configuration decisions and reduces the computational burden on the generative AI model.

The server constructs one or more prompt sentences for a generative AI model based on the demand prediction results and event information related to the time and area ranges of interest.

The server retrieves event information, including the type, location, duration, and expected scale of planned events that may affect network demand. The server formats a prompt sentence that describes, in natural language, the recent and predicted demand patterns, the events, and the available network resources. For example, the server may generate a prompt sentence such as: “Using the following predicted traffic per area and hour, and considering that a large outdoor music event will take place in Area A on Saturday from 16:00 to 22:00, generate an optimal configuration plan for base stations and routers in Areas A, B, and C that minimizes congestion risk and maintains average latency below a specified threshold for video streaming and voice calls.”

In another example, the server may generate a prompt sentence such as:

“Based on the device distribution, historical congestion records, and the listed upcoming events in the city center, determine per-hour capacity adjustments, carrier activations, and priority rules that should be applied to maintain stable service quality over the next 48 hours.”

The server injects structured summaries, such as lists of time-area cells with their predicted demand and historical error patterns, into the prompt sentence as human-readable tables or bullet lists. By doing so, the server shapes the generative AI model's attention toward relevant numerical patterns and context, thereby improving the reliability and consistency of the generated configuration plans.

The server transmits the prompt sentence and, in some embodiments, additional machine-readable data representing the demand prediction data, to a generative AI model. In one embodiment, the generative AI model is implemented as a transformer-based neural network having multiple layers of self-attention and feedforward sub-layers, each with learned weight matrices. The generative AI model receives the prompt sentence tokenized into vector representations and processes them through multi-head attention mechanisms to compute context-aware token embeddings. These embeddings are passed through non-linear transformations and stacked layers, resulting in a sequence of output tokens that form a configuration plan expressed in structured text. In some embodiments, the server provides an encoding of the demand prediction data as a compact textual summary or as a structured block that the model can parse as part of the prompt.

The server causes the generative AI model to generate a configuration plan that includes optimal setting contents for each time-area cell, such as bandwidth allocations, carrier activations, and priority weights for different traffic classes. The server may specify output constraints in the prompt sentence to ensure that the configuration plan is expressed in a machine-parsable format, for example by requesting semicolon-separated lines with defined fields. By enforcing such structured outputs, the server can parse the generated configuration plan reliably and apply post-processing without manual interpretation.

The server is configured to adapt the prompt sentence over time based on feedback. The server computes demand prediction errors by comparing predicted demand with actual measured traffic and performance metrics. The server identifies patterns of underestimation or overestimation for particular event types, regions, or time-of-day segments. The server embeds such error patterns into subsequent prompt sentences, for example by including statements such as “Previous forecasts for large outdoor concerts underestimated traffic by approximately 30%, so increase the projected capacity for similar events accordingly.” Through this feedback mechanism, the server modifies the informational content and emphasis of the prompt sentence. This adaptation changes which features the generative AI model focuses on, improving the precision of future configuration plans. The server thereby implements a computer-centric improvement in that the server dynamically modifies the input representation to the model using numeric feedback rather than static, manually-designed prompts.

The server generates setting information for communication apparatuses based on the configuration plan output from the generative AI model. The server parses the model's output string, validates the format, and maps the recommended parameters to specific configuration fields of base stations, routers, and other devices. The server translates generic time-area recommendations into device-level schedules by using a mapping between area identifiers and device identifiers maintained in a topology database. The server then constructs device-specific commands compatible with management protocols or controller application programming interfaces. Because the setting information is derived from a structured plan aligned with the model's recommendations and the network topology, the server avoids inconsistent configurations and reduces manual mapping errors.

The server transmits the setting information to the communication apparatuses through a communication management apparatus. The server interacts with a network management system or a software-defined network controller that can apply configuration changes in a coordinated manner. The server schedules configuration tasks to be applied at specified times and monitors their execution status. The server thereby performs direct control of physical devices in the communication network, resulting in changes to radio resource allocation, routing tables, and quality-of-service policies in the real world. This device-level control illustrates that the invention is not limited to abstract data processing but is implemented as concrete machine control that affects actual network behavior.

The server acquires operation state information of the communication apparatuses by using detection apparatuses and monitoring programs installed on or associated with the communication apparatuses. The server receives metrics such as device status, alarm codes, error logs, temperature, and link states. The server aggregates and analyzes these metrics in time windows aligned with the demand prediction and configuration periods. When the server detects an abnormality, such as repeated packet drops or a device entering a degraded state, the server constructs a new prompt sentence describing the abnormality, the device configuration, and the surrounding network context.

For example, the server may generate a prompt sentence such as:

“A base station in Area D is reporting repeated link failures after the last configuration update. Here is the recent configuration history, alarm log summary, and traffic pattern. Propose a step-by-step repair procedure that minimizes service disruption while restoring normal operation.”

The server inputs this prompt sentence, along with summarized diagnostic data, to the generative AI model. The generative AI model processes the prompt and generates a repair procedure plan that may include actions such as reverting specific parameters, restarting certain processes, or switching traffic to redundant routes. The server validates the syntax of the suggested procedures and maps them to a predefined set of safe operations implemented by an automatic repair processing program. The server then executes the repair steps automatically, such as sending commands to restart a module or to change routing, while monitoring the effects on performance metrics.

The server thereby achieves an adaptive remediation mechanism where the repair steps are not fixed static scripts but are generated in response to the particular context of each incident. This approach differs from simple automation of human tasks, because the server uses numeric features, structured diagnostics, and past error patterns to guide the generative model toward new combinations of available actions. The server's use of a generative AI model to synthesize repair sequences under defined safety constraints improves the coverage of fault cases and reduces the time to restore service, leading to a measurable reduction in downtime and manual intervention.

The server integrates the demand prediction results, the configuration plan, and the execution status of the repair processes and transmits notification information to the network management terminal used by the user. The server structures the notification information so that it includes both high-level summaries and detailed logs, and stores it as learning data for future analysis.

The server uses this learning data to adjust how it constructs prompt sentences and to refine thresholds for anomaly detection. Over time, the server reduces the number of false positives and unnecessary configuration changes, which improves both computational efficiency and stability in the network.

The user accesses the network management terminal to review the generated predictions, configuration plans, and remediation results. The user may manually approve, modify, or reject certain actions through a management interface. However, the system is designed so that most configuration and remediation operations can be executed automatically, with the user focusing on policy-level decisions and special cases.

In some embodiments, the generative AI model is trained or fine-tuned on domain-specific data stored by the server. The server uses a corpus of historical prompts, generated configuration plans, applied settings, and resulting performance metrics to update the model parameters. The server applies a training process where an objective function, such as a weighted combination of prediction accuracy, configuration stability, and service quality metrics, is minimized. The server performs gradient-based optimization of the model's weights using the stored learning data and periodically deploys updated model versions to the inference environment. This closed-loop training process enables the generative AI model to adapt to changes in network architecture, traffic patterns, and device capabilities.

In another embodiment, the server uses a hybrid architecture where a deterministic optimization module post-processes the generative AI model's suggestions. The server first obtains a configuration plan from the generative model, then runs a constrained optimization algorithm that enforces resource limits and safety policies. The server thereby ensures that the final configuration applied to the network not only reflects the model's recommendations but also satisfies hard constraints on capacity, redundancy, and compliance. This hybrid approach enhances robustness and further reduces the need for manual correction.

In yet another embodiment, different generative AI models or different prompt templates are used for different service types or network segments. The server selects a model or template based on criteria such as region type, time-of-day, or historical volatility. This selection mechanism allows the server to tailor the computational strategy to each scenario, improving the accuracy and computational efficiency of the configuration process.

As described above, the server, the terminal, and the user cooperate in a multi-stage process that integrates data acquisition, aggregation, prediction, prompt construction, generative modeling, device control, and remediation. The specific data structures, model architectures, and feedback mechanisms described herein enable the computer system to manage communication networks with improved prediction accuracy, reduced processing overhead, and faster and more reliable remediation compared with conventional systems that employ static rules or manually crafted prompts. The technical effect is achieved because the invention changes how the computer organizes and uses internal data representations and how it interacts with the generative AI model to drive concrete changes in network apparatuses, resulting in measurable improvements in processing speed, resource utilization, and network service quality.

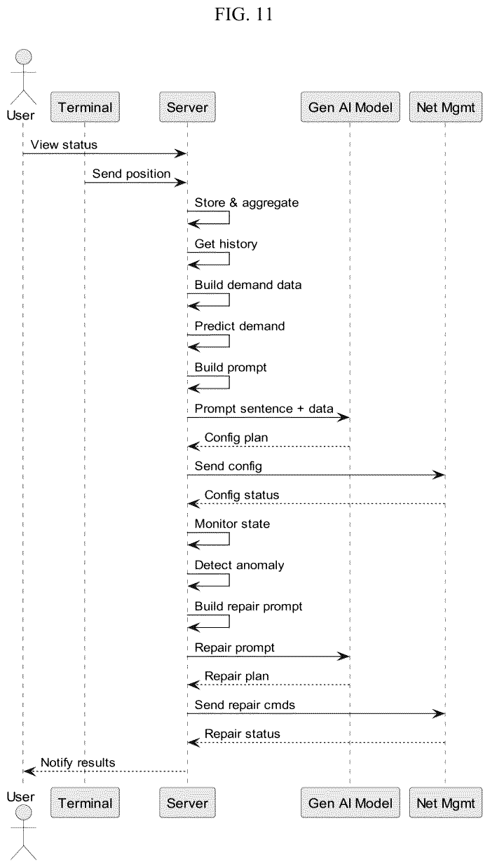

The following describes the processing flow using FIG. 11.

### Step 1

The terminal acquires raw position information of a mobile body.

The terminal uses a positioning sensor and an operating system location service to obtain latitude, longitude, and timestamp information.

Input: satellite signals and sensor readings received by the positioning sensor.

Output: normalized position information including at least a terminal identifier, latitude, longitude, and timestamp.

The terminal performs data processing by converting raw sensor signals into numerical coordinates using the operating system's positioning algorithm, attaching a terminal identifier, and formatting the data into a structured internal record stored in local memory.

### Step 2

The terminal transmits the position information to the server.

The terminal establishes a wireless communication session using a communication modem and a network protocol stack, and periodically sends the latest position information to a predefined server endpoint.

Input: normalized position information stored in the terminal's local memory and a server address.

Output: a network message containing position information transmitted over the communication network to the server.

The terminal performs data processing by serializing the position information into a message format, adding header information such as authentication tokens and timestamps, and executing transmission and retransmission control according to communication protocols.

### Step 3

The server receives and validates the position information from the terminal.

The server listens on a network interface, accepts incoming messages, and parses the received data.

Input: a network message containing position information from one or more terminals.

Output: validated and normalized position records stored in a storage apparatus.

The server performs data processing by decoding the message, extracting fields such as terminal identifier, latitude, longitude, and timestamp, checking validity ranges for coordinates and time, discarding invalid records, normalizing coordinate precision, and converting timestamps to a unified time standard before inserting the records into a database table.

### Step 4

The server aggregates the position information into distribution information.

The server groups stored position records by time interval and area unit and computes statistical values.

Input: a set of position records retrieved from the database for a given time window.

Output: distribution information that indicates counts and related statistics of mobile bodies per time interval and area unit.

The server performs data processing by mapping each position to an area identifier, assigning each timestamp to a time slot identifier, counting records per (time slot, area) pair, and optionally computing averages, variances, or movement metrics, then storing the aggregated results in a separate aggregation table.

### Step 5

The server retrieves historical communication amount information and performance information.

The server accesses a performance database or telemetry store that contains past usage and performance metrics of communication apparatuses.

Input: queries specifying time ranges, area identifiers, and device identifiers.

Output: historical records including traffic volume, error rates, latency, and utilization per time and area.

The server performs data processing by executing database queries, filtering records for the relevant time intervals and areas, and normalizing units and formats so that they are compatible with the time and area indices used for the distribution information.

### Step 6

The server generates demand prediction data by associating distribution information with historical performance information.

The server aligns and combines mobile body distributions with network usage and performance metrics.

Input: distribution information per time and area and historical communication amount information and performance information per time and area.

Output: demand prediction data represented as feature vectors or structured records for each time-area cell.

The server performs data processing by joining the distribution information with the historical metrics on matching time and area keys, constructing feature vectors containing counts of devices, traffic volumes, latency values, error indicators, and trend values, and storing these vectors in a prediction input table ready for numerical modeling.

### Step 7

The server calculates demand prediction results of the communication network.

The server applies a prediction algorithm or a trained model to the demand prediction data to estimate future network demand.

Input: demand prediction data comprising feature vectors for a future prediction horizon.

Output: demand prediction results including predicted traffic, expected congestion levels, and required capacity margins per time and area.

The server performs data processing by loading the prediction model parameters, performing numerical computations such as matrix multiplications and non-linear activations on the feature vectors, computing predicted values for each time-area cell, and writing the prediction results into a dedicated results table.

### Step 8

The server obtains event information related to the time range and area range of the demand prediction results.

The server accesses an event schedule store or external event data source and filters relevant events.

Input: time ranges and area identifiers derived from the demand prediction results.

Output: event information including event types, locations, time ranges, and expected scales associated with the relevant time-area cells.

The server performs data processing by querying event records, matching event locations to area identifiers, associating events with overlapping time intervals, and generating a list or table of events indexed by time and area.

### Step 9

The server constructs a prompt sentence for a generative AI model.

The server converts numerical prediction data and event information into a natural language instruction that describes the configuration task.

Input: demand prediction results and event information for selected time and area ranges.

Output: a prompt sentence including a textual description of predicted demand, events, and required configuration outputs.

The server performs data processing by summarizing key statistics (such as peak predicted traffic and high-risk areas), formatting them into human-readable text, inserting structured lists or short tables into the prompt where appropriate, and arranging instructions that specify the desired form and contents of the configuration plan to be generated.

### Step 10

The server transmits the prompt sentence and associated data to the generative AI model.

The server prepares an inference request and sends it to a model-serving endpoint hosting the generative AI model.

Input: a prompt sentence and optionally additional structured summaries derived from the demand prediction data.

Output: a generated text response from the generative AI model that describes a configuration plan.

The server performs data processing by tokenizing the prompt sentence where required by the interface, packaging the prompt and any supplementary text into a request message, sending the message over a network to the model endpoint, and receiving the output text generated by the model.

### Step 11

The server parses the generated configuration plan.

The server converts the model's textual output into structured configuration items that can be applied to communication apparatuses.

Input: a generated text response describing a configuration plan per time and area.

Output: structured configuration records mapping time-area recommendations to specific parameter settings.

The server performs data processing by splitting the text into lines or segments, extracting fields such as area identifiers, time intervals, bandwidth allocations, and priority levels using parsing rules, validating numerical ranges and syntax, and constructing internal objects or database records representing the desired configuration.

### Step 12

The server maps configuration records to specific communication apparatuses.

The server uses topology and mapping information to translate area-based plans into device-level configurations.

Input: configuration records per time and area and a mapping between area identifiers and device identifiers.

Output: device-level configuration tasks specifying settings and schedules for individual communication apparatuses.

The server performs data processing by looking up which base stations or routers serve each area, assigning corresponding configuration parameters to each device, resolving overlapping or conflicting instructions, and constructing a schedule of configuration commands to be applied to each communication apparatus.

### Step 13

The server generates setting information and sends it to a communication management apparatus.

The server converts device-level configuration tasks into protocol-specific commands or API calls.

Input: device-level configuration tasks for communication apparatuses.

Output: setting information transmitted to the communication management apparatus for execution on the communication apparatuses.

The server performs data processing by formatting configuration data into command payloads compatible with management protocols, grouping commands into transactions, attaching execution times and rollback conditions, and transmitting the payloads to the communication management apparatus over a secure connection.

### Step 14

The server monitors execution and updates the status of applied configurations.

The server receives acknowledgments and status messages from the communication management apparatus or communication apparatuses.

Input: execution status messages and device responses related to configuration commands.

Output: updated records indicating success, failure, or partial application of configuration tasks.

The server performs data processing by correlating responses with original configuration commands, updating status fields in a configuration tracking table, logging errors and warnings, and computing statistics on configuration success rates per device and per time.

### Step 15

The server acquires operation state information and detects abnormalities.

The server collects performance metrics and status indicators from communication apparatuses and analyzes them for abnormal patterns.

Input: operation state information including metrics such as error counts, link status, throughput, and latency.

Output: abnormality detection results identifying devices or areas with faults or performance degradation.

The server performs data processing by aggregating metrics over defined time windows, comparing them against thresholds or baseline models, detecting events such as persistent packet loss, repeated re-transmissions, or sudden capacity drops, and generating records that indicate the type and severity of each detected abnormality.

### Step 16

The server constructs a repair-related prompt sentence for the generative AI model.

The server describes the detected abnormality, recent configuration history, and surrounding network context in natural language.

Input: abnormality detection results, configuration history, and local performance metrics for affected devices and areas.

Output: a repair-oriented prompt sentence specifying the abnormal situation and requesting a repair procedure plan.

The server performs data processing by summarizing the abnormality type, including recent parameter changes, listing relevant alarms or log excerpts, and composing an instruction that asks for a step-by-step repair procedure subject to constraints such as minimizing service disruption.

### Step 17

The server sends the repair-related prompt sentence to the generative AI model and receives a repair procedure plan.

The server interacts with the generative AI model to obtain recommended repair actions.

Input: a repair-oriented prompt sentence and associated diagnostic summaries.

Output: a generated text response describing a repair procedure plan.

The server performs data processing by packaging the prompt and summaries into a model request, sending the request to the model endpoint, waiting for the generated output, and storing the resulting text for further analysis.

### Step 18

The server converts the repair procedure plan into executable repair tasks and executes them.

The server parses the generated text and maps high-level repair steps to predefined safe operations.

Input: a generated text response describing a repair procedure and a catalog of executable repair operations supported by the communication management apparatus.

Output: executable repair tasks executed on the communication apparatuses and updated device states.

The server performs data processing by parsing instructions such as “revert parameter X,” “restart module Y,” or “reroute traffic from device A to device B,” matching them to concrete commands in a repair operation catalog, ordering the commands according to dependencies, executing them through the communication management apparatus, and monitoring the resulting changes in performance metrics.

### Step 19

The server integrates prediction results, configuration plans, and repair execution status and notifies the user.

The server compiles a comprehensive view of network demand, applied configurations, and remediation actions for presentation.

Input: demand prediction results, configuration records and their execution statuses, abnormality and repair records, and related performance metrics.

Output: notification information transmitted to the network management terminal and stored as learning data.

The server performs data processing by joining various records along time, area, and device dimensions, generating summaries and detailed logs, formatting them for display or reporting, transmitting them to the network management terminal for the user, and archiving them to serve as learning data for refining future demand prediction data, prompt sentences, and configuration strategies.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional mobile communication management systems predict network demand and configure network parameters using fixed statistical models, static rules, or manually designed policies. Such systems typically aggregate coarse-grained traffic statistics at a network level and then apply pre-defined configuration templates to base stations and terminals. As a result, they exhibit several technical limitations when faced with highly dynamic and fine-grained traffic patterns generated by mobile devices and autonomous vehicles.

First, existing systems are not designed to efficiently handle spatiotemporal variability of traffic that depends on both time and precise geographic location. When a large number of mobile devices and autonomous mobile bodies move simultaneously in urban areas, demand can fluctuate rapidly within short time intervals and small spatial units. Rule-based or static models struggle to accurately predict future demand per time slot and per area, resulting in suboptimal allocation of communication resources. This typically leads to increased packet loss, higher latency, and unnecessary over-provisioning of capacity, thus degrading overall system performance.

Second, many current systems treat network configuration computation and device-level control separately, without an integrated feedback loop that takes into account fine-grained application-level traffic at terminals. Terminals often lack adaptive policies that align with network-level optimization results. Consequently, terminals may continue to transmit non-critical or low-priority traffic even when the network is congested, exacerbating congestion and undermining the effect of network-side optimization. This separation leads to inefficient use of available bandwidth and unstable quality of service, especially for latency-sensitive traffic such as control messages and sensor data from autonomous mobile bodies.

Third, base station monitoring and fault handling are often reactive and rely heavily on human intervention. Existing monitoring tools may detect alarms or simple threshold violations, but they do not effectively utilize predictive analytics to estimate failure probabilities or to automatically compute bypass configuration plans before an actual failure occurs. As a result, when a base station degrades or fails, there can be significant downtime and performance degradation while operators manually reconfigure neighboring cells and reallocate communication resources. This reactive approach limits the robustness and resilience of the communication infrastructure.

Fourth, prior approaches do not fully exploit generative AI models that can accept structured spatiotemporal demand prediction results and network conditions as prompt sentences and then generate detailed, context-aware network configuration information. Existing machine learning systems are often narrowly focused on pure prediction tasks and do not integrate prediction output and network constraints in a flexible, generative manner to produce holistic configuration plans including resource allocation, quality control parameters, and fallback strategies. This leads to fragmented optimization, where prediction and configuration are decoupled and fail to adapt to complex, real-world conditions.

Fifth, conventional systems do not implement a continuous, closed feedback loop that uses up-to-date communication state information and application-specific traffic information from terminals mounted on autonomous mobile bodies to refine both demand prediction and network configuration in near real time. Without such feedback, the system cannot effectively learn from actual traffic behavior and cannot promptly adjust configuration to reduce delay and avoid disconnection for critical communications.

Accordingly, there is a need for a computer-implemented technique that (i) accurately predicts communication demand per time interval and spatial unit by using detailed position information and past traffic information, (ii) uses a generative AI model with prompt sentences to generate network configuration information that is adapted to predicted demand and network conditions, (iii) automatically configures both network-side elements and terminal-side behavior in a coordinated manner, (iv) predicts base station failures and proactively executes bypass and resource redistribution plans, and (v) implements a feedback mechanism that updates predictions and configurations based on actual communication state of autonomous mobile bodies. By addressing these technical challenges, the invention aims to improve the functioning of the computer-based network control system itself, resulting in more stable throughput, reduced latency, and improved robustness against congestion and faults.

The specific processing by the specific processing unit 290 of the data processing device 12 in Application Example 1 is realized by the following means.

The present invention provides a server comprising a processor configured to acquire position information from a mobile device and store the position information in association with time information, obtain the stored position information and past traffic information related to a communication apparatus and generate a demand prediction result that estimates future communication demand for predetermined time intervals and predetermined spatial units, convert the demand prediction result and network configuration conditions into a prompt sentence as input data for a generative AI model, input the prompt sentence into the generative AI model and cause the generative AI model to generate network configuration information including communication resource allocation information and quality control information for each of the time intervals and the spatial units, set control parameters including bandwidth allocation, priority control and handover conditions for a communication control apparatus or a base station apparatus based on the network configuration information and automatically change operation of the communication control apparatus or the base station apparatus, transmit, to a terminal device, policy information relating to communication control on a terminal side included in the network configuration information and cause the terminal device to perform transmission control and reception control for each application type, bandwidth limitation and adjustment of reporting intervals, acquire operation state information and failure sign information of the base station apparatus via a sensor apparatus or monitoring software, generate a prompt sentence for the generative AI model based on the operation state information, input the prompt sentence into the generative AI model to obtain a failure occurrence probability and a bypass configuration plan and, when the failure occurrence probability exceeds a predetermined threshold, activate an automatic recovery module that performs switching of a communication route to another base station apparatus or redistribution of communication resources based on the bypass configuration plan, and acquire communication state information and application-specific traffic information from a terminal device mounted on an autonomous mobile body and perform feedback processing that updates the demand prediction result and the network configuration information so as to reduce delay and avoid disconnection for communications related to the autonomous mobile body. This enables improvement of the operation of the computer-implemented communication control system by providing more accurate spatiotemporal demand prediction, automated generation of context-aware network configuration via the generative AI model using prompt sentences, coordinated optimization of network-side and terminal-side behavior, proactive base station fault mitigation and continuous feedback-based refinement, thereby reducing latency, packet loss and service disruption under highly dynamic traffic conditions.

The term “processor” refers to a hardware or virtual computation unit, such as a central processing unit or a processing core in a computing apparatus, that executes machine-readable instructions to perform data acquisition, analysis, and control operations described in the present specification.

The term “mobile device” refers to a portable communication apparatus carried by a user or mounted on a vehicle, which is capable of wireless communication with a network and of obtaining position information using a positioning function.

The term “position information” refers to data indicating a geographic location of a device, including at least one of latitude, longitude, altitude, speed, and direction, optionally associated with time information and accuracy information.

The term “time information” refers to data indicating a time point or time interval associated with an event or measurement, such as a timestamp or a sequence of time slots.

The term “traffic information” refers to data representing communication load in a network, including at least one of throughput, number of sessions, packet count, latency, or packet loss, measured for a communication apparatus, a base station apparatus, or a spatial unit.

The term “communication apparatus” refers to any network element that participates in transmission or reception of data in a communication network, including but not limited to a base station apparatus, a communication control apparatus, a router, or a switch.

The term “demand prediction result” refers to information generated by computation that estimates future communication demand for one or more time intervals and spatial units, based on position information, traffic information, or other related data.

The term “spatial unit” refers to a region in physical space used as a unit for analysis or control, such as a cell area, a geographic grid, or a coverage area associated with a base station apparatus.

The term “network configuration conditions” refers to constraints, requirements, and environmental parameters relating to the configuration of a communication network, including at least one of available bandwidth, topology, quality of service requirements, priority policies, and regulatory limitations.

The term “prompt sentence” refers to a text or structured instruction that is provided as input to a generative AI model, the text or instruction encoding at least one of a demand prediction result, network configuration conditions, or operation state information, in order to cause the generative AI model to generate a corresponding output.

The term “generative AI model” refers to a machine learning model configured to generate output data, such as network configuration information or bypass configuration plans, in response to input data or a prompt sentence, the model being trained using sample data to learn patterns and relationships in the data.

The term “network configuration information” refers to information indicating settings used to control operation of a communication network, including at least one of communication resource allocation information, quality control information, routing policies, and fallback configuration plans.

The term “communication resource allocation information” refers to information specifying how communication resources, including frequency bands, time slots, codes, or throughput limits, are assigned to one or more communication entities such as users, terminals, or base station apparatuses.

The term “quality control information” refers to information specifying quality of service control parameters, including at least one of latency targets, priority classes, packet scheduling policies, and permissible packet loss rates.

The term “communication control apparatus” refers to a device or functional entity that manages or controls communication operations in a network, such as a base station controller, a core network controller, or a software-defined networking controller.

The term “base station apparatus” refers to a wireless communication apparatus that provides radio coverage to one or more mobile devices, performing at least transmission, reception, and radio resource control within a cell or coverage area.

The term “control parameters” refers to one or more values that determine behavior of a communication control apparatus or a base station apparatus, including at least bandwidth allocation, priority control parameters, and handover conditions.

The term “bandwidth allocation” refers to assignment of a communication capacity, such as a data rate or frequency resource, to one or more communication flows, users, or spatial units.

The term “priority control” refers to control over the order or importance with which communication flows or data packets are processed, scheduled, or transmitted, including assignment of different priority levels to different application types or user groups.

The term “handover conditions” refers to criteria or thresholds used to determine when a communication session for a mobile device should be transferred from one base station apparatus to another base station apparatus.

The term “terminal device” refers to an end-user apparatus that communicates with a network, including at least one of a smartphone, an in-vehicle communication unit, or another computing device capable of wireless communication.

The term “policy information” refers to information that specifies rules or policies for controlling communication behavior of a terminal device, including at least one of traffic prioritization, bandwidth limitation rules, and reporting intervals.

The term “application type” refers to a classification of software or service executed on a terminal device, such as a real-time control application, a sensor data application, a streaming media application, or a background data application.

The term “transmission control and reception control” refers to operations performed by a terminal device to manage sending and receiving of data, including at least rate control, queuing, prioritization, and selection of transmission timing.

The term “reporting intervals” refers to time intervals between successive transmissions of status reports, measurement data, or other periodic messages from a terminal device or a network element.

The term “sensor apparatus” refers to a hardware device that measures physical or operational quantities related to a communication apparatus, such as temperature, power, signal strength, or error rate, and outputs the measurements as digital data.

The term “monitoring software” refers to a program or software component configured to acquire, process, and analyze operation state information or failure sign information of a communication apparatus or a base station apparatus.

The term “operation state information” refers to information indicating an operational condition of a communication apparatus or a base station apparatus, including at least one of CPU load, memory usage, radio link quality, alarm status, and current configuration state.

The term “failure sign information” refers to information indicating a symptom, anomaly, or condition that may precede a failure of a communication apparatus or a base station apparatus, such as an abnormal error rate, repeated alarms, or degradation trends.

The term “failure occurrence probability” refers to a probability value indicating likelihood that a failure will occur in a communication apparatus or a base station apparatus within a specified future time period.

The term “bypass configuration plan” refers to information describing a configuration that redirects at least a part of communication traffic from a communication apparatus or a base station apparatus at risk of failure to one or more alternative communication paths or base station apparatuses.

The term “automatic recovery module” refers to a functional unit implemented in software, hardware, or a combination thereof, which automatically executes recovery actions such as route switching, resource redistribution, or configuration changes in response to a predicted or detected failure condition.

The term “communication route” refers to a logical or physical path through which data is transmitted between a terminal device and another communication apparatus, including intermediate nodes such as base station apparatuses and communication control apparatuses.

The term “redistribution of communication resources” refers to modification of allocation of communication resources among communication entities or spatial units to respond to changes in demand or failures, including shifting resources from a first base station apparatus to a second base station apparatus.

The term “autonomous mobile body” refers to a mobile platform capable of moving without continuous human control by using sensors, control algorithms, and communication with external systems, such as an autonomous vehicle or an autonomous robot.

The term “communication state information” refers to information indicating current communication performance or status related to a terminal device, including at least one of throughput, latency, packet error rate, disconnection events, and radio quality.

The term “application-specific traffic information” refers to information describing communication volume or characteristics associated with one or more application types on a terminal device, including data rate, packet size distribution, or periodicity per application type.

The term “feedback processing” refers to processing that adjusts at least one of a demand prediction result and network configuration information based on newly acquired communication state information or application-specific traffic information, such that subsequent predictions and configurations reflect actual behavior of the system.

In one embodiment, a server, a terminal, and a user cooperate to implement the invention. The server includes at least one processor, a memory, a non-volatile storage device, one or more network interface controllers, and optionally one or more accelerators such as a graphics processing unit. The terminal includes a processor, a memory, a wireless communication module, and a position detection module such as a satellite positioning receiver.

The user operates or rides in an autonomous mobile body equipped with the terminal.

The server executes a communication control program stored in the memory. The communication control program is implemented using an operating system, a runtime environment, and one or more software frameworks. In one embodiment, the server uses an operating system such as a general-purpose server operating system, a database management system such as a relational database engine, a distributed data processing framework, and a machine learning framework such as a tensor computation library and a neural network training and inference library. The server uses these software components to perform data acquisition, pre-processing, feature generation, neural network inference, optimization, and configuration distribution.

The terminal executes a terminal-side control program. The terminal uses an operating system for a mobile or embedded device, a network stack implementing wireless communication protocols, a position acquisition API that obtains position information from the satellite positioning receiver or other sensors, and a local policy engine that adjusts traffic control and reporting behavior based on policy information received from the server.

The user operates or rides in the autonomous mobile body without needing to manually configure network parameters. The user interacts with applications such as navigation software, streaming media players, and remote monitoring interfaces that rely on the terminal's communication functions, while the server and the terminal cooperate to maintain a stable and optimized communication environment.

In one embodiment, the server uses position information provided by the terminal as input data.

The terminal obtains position information by calling a position acquisition API that interfaces with a satellite positioning receiver or other sensors such as inertial measurement units. The terminal packages the position information with a device identifier, a time value, and accuracy metadata, and transmits these records over a wireless communication link to the server. The server receives these records through a network interface and stores them in a structured data store, such as a table that includes fields for device identifier, time, latitude, longitude, speed, and current serving base station identifier.

The server also aggregates past traffic information. The server obtains traffic information from one or more network monitoring systems. The traffic information includes measurements of throughput, number of sessions, packet loss, and latency for each base station or spatial unit, and for each discrete time slot. The server stores this traffic information in a data structure such as a time-series table keyed by base station identifier and time slot. The server joins the position information with the traffic information to construct a spatiotemporal dataset representing, for each time slot and spatial unit, the positions and counts of terminals, and the corresponding communication load.

The server performs data pre-processing in a non-trivial way to improve computation efficiency and prediction accuracy. The server converts continuous geographic coordinates into discrete spatial units, for example by mapping latitude and longitude to grid cell indices or to base station coverage identifiers. The server aggregates individual device records in each spatial unit and time slot into statistics such as the number of devices, average speed, and distribution of movement directions. The server normalizes numerical features to a common scale and encodes categorical identifiers using integer indices or embedded vectors. The server constructs input tensors where one dimension represents time, one dimension represents spatial units or base stations, and one or more dimensions represent feature channels.

In one embodiment, the server implements a generative AI model as a neural network architecture that processes the spatiotemporal tensors and prompt sentences. The generative AI model includes an embedding layer that transforms categorical indices into dense vectors, one or more temporal encoding layers such as a positional encoding module, and a stack of encoder-decoder blocks based on attention mechanisms. Each encoder-decoder block includes a multi-head self-attention sublayer, a cross-attention sublayer, and a feed-forward network with non-linear activation functions. The model receives, as input, a combination of numerical features and textual instructions. The server converts the numerical features into an internal representation and concatenates or fuses this representation with tokens derived from prompt sentences.

The server generates a prompt sentence for the generative AI model. The prompt sentence encodes the prediction task in natural language or structured text so that the generative AI model can interpret the context and constraints. For example, the server generates a prompt sentence such as:

“The server has location logs and traffic measurements for the last 24 hours around Tokyo Station. Predict network demand for each 5-minute interval over the next 60 minutes for each base station, and output recommended bandwidth and QoS settings.”

In another example, the server generates a prompt sentence such as:

“Using historical data from previous events and current device locations, generate a configuration plan that minimizes packet loss and latency for autonomous vehicles in the Shibuya area during the next 3 hours, and propose fallback settings in case one major base station fails.”

In a simpler example, the server generates a prompt sentence such as:

“Predict the network demand around Tokyo Station for the next 1 hour and optimize communication resources for autonomous vehicles.”

The server tokenizes these prompt sentences into sequences of symbols and maps the symbols to token identifiers. The server feeds both the token identifiers and the encoded numerical features into the generative AI model. The neural network produces output tokens that are decoded into structured network configuration information or prediction values, such as per-area traffic predictions, resource allocation ratios, quality of service parameters, and fallback routes.

In order to ensure that the processing is not merely an abstract idea, the server uses the output of the generative AI model to directly control actual network devices. The server parses the generated network configuration information and maps it to real control parameters used by a communication control apparatus and base station apparatuses. For example, the server sets scheduling weights, maximum bit rates for defined traffic classes, handover thresholds, and admission control parameters in a control database or through device management protocols. The server transmits configuration commands over management interfaces to networking devices, which in turn modify packet scheduling behavior and radio resource assignment in hardware or firmware. The change in control parameters leads to actual changes in radio frame allocation, scheduling decisions, and buffer management inside base station apparatuses.

The server also transmits terminal-side policy information derived from the network configuration information to the terminal. The terminal receives the policy information and applies it to a traffic control module implemented in the operating system or in a middleware component. The terminal changes queueing discipline, traffic shaping parameters, prioritization rules, and reporting frequency based on application type. For example, the terminal sets higher priority and less aggressive bandwidth limitation for control messages and sensor data related to autonomous driving, while assigning lower priority and stricter rate limits to background updates or best-effort streaming. This terminal-level processing directly affects how packets are buffered, scheduled, and transmitted over the wireless link, thereby reducing collisions and retransmissions and improving effective throughput.

In one embodiment, the server monitors base station apparatuses using sensor apparatuses and monitoring software. The server collects measurements such as temperature, CPU utilization, radio error counts, and alarm flags, and stores them as time-series data. The server constructs feature vectors from these measurements, possibly adding derived indicators such as moving averages or anomalies relative to baselines. The server generates a prompt sentence for the generative AI model in order to evaluate failure risks and bypass plans. For example, the server may generate:

“Analyze the following base station metrics over the last 6 hours and predict the probability of failure in the next 30 minutes. If the probability is higher than 70%, propose a reconfiguration plan to reroute traffic.”

The server passes the prompt sentence and feature vectors to the generative AI model, which outputs values representing failure occurrence probabilities and suggestions for bypass configuration plans. The server interprets these outputs and, when a probability exceeds a threshold, activates an automatic recovery module. The automatic recovery module executes a series of control operations, such as pre-emptively shifting part of the traffic load from the at-risk base station to neighboring base stations, adjusting handover parameters to favor alternative cells, and updating routing rules in a communication control apparatus. These operations change actual forwarding behavior and radio resource usage in the network.

The generative AI model used in these embodiments is trained prior to deployment. The server or an offline training system constructs a training dataset consisting of input-output pairs. For demand prediction and configuration generation, the input includes historical position information, traffic information, and network conditions, encoded as tensors and prompt sentences. The output includes known future traffic, known applied configurations, and performance metrics. During training, the server uses a loss function such as a combination of mean squared error for numerical predictions and cross-entropy for token-level outputs. The server performs weight updates using gradient-based optimization algorithms, such as stochastic gradient descent with momentum or adaptive gradient methods. The server may employ data augmentation techniques, such as the addition of noise to time indices or the random masking of certain features, to improve robustness. The training process results in weight parameter values that cause the generative AI model to produce accurate predictions and effective configuration plans.

The server thereby improves computer technology in several ways. First, by structuring spatiotemporal data into tensors and by using a neural network architecture specifically adapted to such data, the server reduces prediction error compared to traditional rule-based or simple statistical models. Accurate prediction at a finer granularity enables more efficient resource allocation, which directly reduces congestion and improves throughput. Second, by integrating prediction and configuration generation in a single generative AI model, the server avoids the overhead and error accumulation associated with separate systems, thereby improving processing speed and quality of results. Third, by mapping model outputs to concrete control parameters and by executing device-specific control sequences, the server reduces communication load and packet loss through optimized resource allocation, rather than simply reporting predicted values to a human operator.

The server uses non-conventional processing rules that differ from human manual procedures.

For example, the server uses learned mappings between prompt sentences, numerical features, and configuration outputs that reflect complex patterns in past data. The server does not apply a fixed rule table but uses attention mechanisms to dynamically focus on relevant time intervals, spatial units, and conditions. The server uses multi-head attention to differentiate among different types of features and uses layer normalization and residual connections to stabilize deep network training and inference. These structural choices improve convergence speed and inference stability, which is particularly important for real-time network control.

The terminal also contributes to technical improvements. By implementing multiple traffic queues and using priority-based scheduling at the terminal, the terminal reduces the amount of unnecessary retransmissions caused by oversaturation of the wireless link. The terminal aligns its behavior with the network-side configuration, which is not commonly implemented in conventional systems where terminal behavior is fixed. The terminal dynamically changes reporting intervals for status messages, lowering reporting frequency when the server has sufficient information and increasing it when the server requires more detailed data for refined prediction. This adaptability reduces communication overhead while maintaining prediction quality.

The user benefits from the improved communication environment without needing to understand internal operations. The user uses applications normally while the autonomous mobile body moves through regions with varying network conditions. The server and the terminal, by virtue of the described architecture, maintain stable connectivity and low latency for safety-critical data, thereby enabling reliable autonomous operation and high-quality user experiences.

Alternative embodiments are also possible. The server may use a different neural network architecture, such as a recurrent neural network with gated units, a temporal convolutional network, or a hybrid architecture that combines convolution, recurrence, and attention. The server may store data in a key-value store or a graph database rather than a relational database.

The generative AI model may be deployed entirely on-premises or may be accessed through an external inference service. The prompt sentence may use a domain-specific language rather than natural language, and the model may be fine-tuned to interpret this language. The terminal may run on different hardware configurations, such as an embedded controller in an industrial mobile robot, or a modular communication unit attached to different vehicles.

In another variation, the server may generate different sets of configuration policies for different categories of terminals, such as emergency vehicles, public transportation vehicles, and general-purpose vehicles. The generative AI model may be trained to output policies that satisfy predefined fairness or safety constraints across these categories. The automatic recovery module may include alternative algorithms, such as solving an optimization problem to minimize expected service disruption subject to capacity constraints when constructing bypass plans.

In all of these embodiments, the server and the terminal cooperate to execute concrete control actions on physical communication devices based on outputs produced by a generative AI model driven by prompt sentences. The described data structures, model architectures, and control operations provide a concrete technical implementation that improves the functioning of the communication control system and the underlying computer hardware, rather than merely automating a human business process.

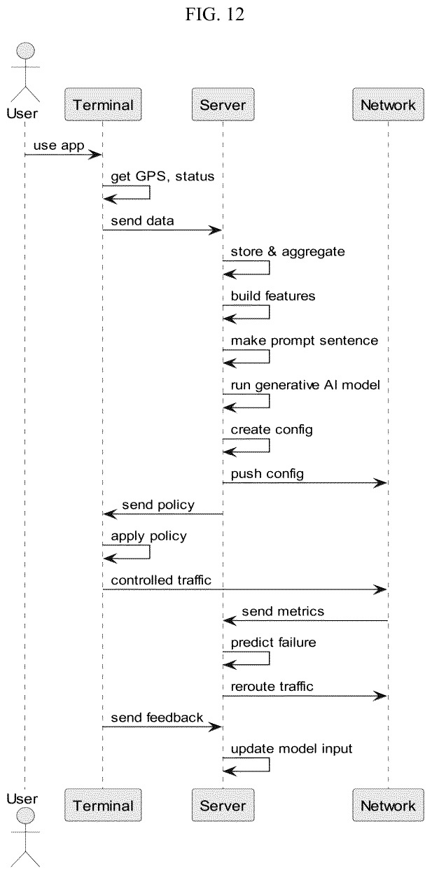

The following describes the processing flow using FIG. 12.

### Step 1

The terminal acquires position information and status information.

The terminal uses a position acquisition API to obtain latitude, longitude, speed, and time from a positioning module, and reads a current serving cell identifier and radio quality indicators from a communication module.

The input is raw sensor readings (satellite signals, radio measurements, internal clock values), and the output is a structured record that includes a terminal identifier, time, geographic coordinates, speed, and cell identifier.

The terminal converts the raw sensor readings into this structured record by invoking OS-level APIs, converting coordinates to a standard format, attaching a timestamp, and packaging the data into a message.

### Step 2

The terminal transmits the structured record to the server.

The terminal sends the message to a predefined server endpoint using a secure protocol over a wireless network.

The input is the structured record generated in Step 1, and the output is a network request containing the record in a serialized format.

The terminal creates a request header with authentication information, encodes the record (for example into JSON or another serialization format), and uses a communication stack to enqueue and transmit the request.

### Step 3

The server receives and stores position and status data from multiple terminals.

The server accepts incoming requests through a network interface and validates their format and authentication tokens.

The input is a stream of serialized records from many terminals, and the output is normalized entries stored in a data repository and, optionally, in a streaming buffer.

The server parses each serialized record, converts field types into internal representations, checks for missing or inconsistent fields, and inserts valid records into tables or time-series collections keyed by device identifier, time, and spatial unit.

### Step 4

The server aggregates past traffic information and associates it with stored position information.

The server retrieves traffic metrics from monitoring systems, such as throughput and latency per base station and time slot, and joins these metrics with the stored position records.

The input is (i) historical traffic metrics indexed by time and base station and (ii) position records indexed by time and terminal, and the output is a spatiotemporal dataset indexed by time slots and spatial units.

The server converts geographic coordinates into spatial unit identifiers, groups terminals by spatial unit and time slot, calculates aggregate statistics such as device counts and average speed, and merges these statistics with corresponding traffic metrics into multi-dimensional arrays or tables.

### Step 5

The server constructs feature tensors and auxiliary context for the generative AI model.

The server converts the spatiotemporal dataset into numerical feature vectors for each time slot and spatial unit.

The input is the aggregated dataset from Step 4, and the output is a set of tensors in which one dimension represents time, one dimension represents spatial units or base stations, and remaining dimensions represent features.

The server normalizes continuous variables, encodes categorical identifiers as indices, fills missing values using interpolation or default values, and arranges the processed features into contiguous memory blocks suitable for neural network input.

### Step 6

The server generates a prompt sentence describing the prediction and configuration task.

The server reads configuration conditions such as time horizon, spatial scope, and policy constraints, and converts them together with a summary of recent data into a textual instruction.

The input is metadata about the prediction task (for example region, time range, required outputs) and system constraints, and the output is a textual prompt sentence.

The server inserts parameter values (such as “next 60 minutes” or “for each base station”) into a template and produces a sentence such as “Predict the network demand around Tokyo Station for the next 1 hour and optimize communication resources for autonomous vehicles.”

### Step 7

The server prepares combined input for the generative AI model.

The server tokenizes the prompt sentence and aligns the tokens with the feature tensors generated earlier.

The input is the prompt sentence from Step 6 and the feature tensors from Step 5, and the output is a composite model input consisting of token sequences and numerical feature arrays.

The server maps words or symbols in the prompt to token identifiers, creates attention masks, associates each token with positional indices, and encapsulates the token sequence and feature tensors into a data structure defined by the model framework.

### Step 8

The server performs inference using the generative AI model to obtain demand predictions and configuration candidates.

The server forwards the composite input through a neural network that includes embedding layers, attention layers, and feed-forward layers.

The input is the composite model input from Step 7, and the output is a sequence of model outputs representing predicted traffic values and configuration parameters in encoded form.

The server runs matrix multiplications, applies activation functions, computes attention weights to focus on relevant times and locations, and produces logits or numeric predictions that represent expected demand, congestion probabilities, and resource allocation suggestions for each time interval and spatial unit.

### Step 9

The server decodes and structures the model outputs into network configuration information.

The server interprets the raw outputs of the generative AI model as specific parameter values and policy rules.

The input is the encoded prediction and configuration outputs from Step 8, and the output is structured network configuration information comprising communication resource allocation information, quality control information, and fallback plans.

The server converts predicted values into resource allocation ratios, maps token sequences to human-readable parameter names, applies bounds and constraints to ensure feasibility, and organizes the results into data structures keyed by base station, time slot, and traffic class.

### Step 10

The server computes concrete control parameters for communication control apparatuses and base station apparatuses.

The server refines the high-level configuration information into device-specific settings such as bandwidth limits, scheduling weights, and handover thresholds.

The input is the network configuration information from Step 9 and the current device capabilities and constraints, and the output is a set of control parameters formatted for each device.

The server solves constraint equations or optimization subproblems if necessary, translates abstract priorities into numeric weights accepted by device firmware, and generates configuration commands that specify parameter names and target values.

### Step 11

The server transmits control parameters to communication control apparatuses and base station apparatuses.

The server sends configuration commands via management interfaces and waits for acknowledgments.

The input is the device-specific control parameters from Step 10, and the output is updated configuration states on the network devices.

The server encapsulates control parameters in protocol messages, sends them using management protocols, receives confirmation or error responses, and logs the success or failure of each configuration change.

### Step 12

The server generates and transmits terminal-side policy information to terminals.

The server extracts portions of the network configuration information that apply to terminal behavior and converts them into concise policies.

The input is the network configuration information from Step 9 and rules for mapping network-side decisions to terminal policies, and the output is a policy message per terminal.

The server creates rules describing which application types receive higher or lower priority, what maximum bit rates apply to each class, and how often status should be reported, then packages these rules into messages addressed to specific terminals and transmits them over a communication channel.

### Step 13

The terminal receives and applies terminal-side policy information.

The terminal decodes the policy message and updates local traffic control settings.

The input is the policy message from Step 12, and the output is an updated internal state controlling transmission control, reception control, and reporting intervals.

The terminal verifies authenticity of the message, parses policy entries, maps application identifiers to policy rules, configures queue structures and rate limiters in the operating system, and adjusts timers for periodic reports.

### Step 14

The terminal controls application data transmission and reception according to the applied policy.

The terminal inspects outgoing and incoming packets, classifies them into application types, and schedules them based on priority and bandwidth limits.

The input is the stream of packets generated or received by applications along with the applied policy, and the output is a reordered and rate-controlled packet stream sent over the wireless interface.

The terminal tags packets with priority levels, places them into separate queues, selects packets for transmission according to a scheduling algorithm, applies rate limiting to low-priority queues, and discards or delays packets when dictated by the policy.

### Step 15

The server monitors operation state information and failure sign information from base station apparatuses.

The server collects metrics from sensors and monitoring software and stores them as time-stamped records.

The input is periodic measurement reports containing values such as temperature, utilization, and error counts, and the output is a processed dataset suitable for failure risk analysis.

The server parses the reports, normalizes measurement units, computes derived indicators such as moving averages or anomaly scores, and arranges them into sequences indexed by device and time.

### Step 16

The server generates a prompt sentence and model input for failure prediction and bypass planning.

The server summarizes recent operation state information and failure signs, and formulates a textual instruction describing the failure prediction task.

The input is the processed dataset from Step 15 and configuration data specifying thresholds and planning horizons, and the output is a prompt sentence and feature vectors.

The server creates a sentence such as “Analyze the following base station metrics over the last 6 hours and predict the probability of failure in the next 30 minutes. If the probability is higher than 70%, propose a reconfiguration plan to reroute traffic.” and extracts feature vectors aligned with the time period described in the sentence.

### Step 17

The server performs inference with the generative AI model for failure prediction.

The server tokenizes the prompt sentence, aligns it with the feature vectors, and executes the model.

The input is the prompt sentence and time-series feature vectors from Step 16, and the output is a failure occurrence probability and a bypass configuration plan in encoded form.

The server runs the neural network with these inputs, computes attention over time, devices, and features, and returns numeric probabilities and symbolic recommendations about traffic redirection and resource redistribution.

### Step 18

The server activates an automatic recovery module based on the failure prediction results.

The server evaluates whether the failure occurrence probability exceeds a threshold and, if so, initiates reconfiguration operations.

The input is the failure probability and bypass configuration plan from Step 17, and the output is a set of updated control parameters and routing rules applied before an actual failure occurs.

The server selects target neighboring base station apparatuses, adjusts resource allocations to increase capacity in those apparatuses, updates handover rules to favor them, and sends corresponding configuration messages to affected devices and communication control apparatuses.

### Step 19

The server collects communication state information and application-specific traffic information from terminals mounted on autonomous mobile bodies.

The server receives periodic status reports that summarize throughput, latency, error rates, and per-application traffic volumes.

The input is the set of reports transmitted by terminals under policies from Step 13 and Step 14, and the output is an updated dataset reflecting actual network performance and usage patterns.

The server parses the reports, associates them with spatial units and time slots, and stores them alongside prediction results and configuration records in a performance database.

### Step 20

The server updates demand prediction and network configuration based on feedback from autonomous mobile bodies.

The server compares predicted values with actual communication state information and adjusts future model inputs and, optionally, model parameters.

The input is the actual performance data from Step 19 and previous prediction and configuration records, and the output is refined feature sets and updated configuration plans for subsequent cycles.

The server computes prediction errors, identifies systematic deviations, modifies scaling factors or feature weights in pre-processing, and may trigger retraining or fine-tuning of the generative AI model so that subsequent predictions and generated configurations better match real-world behavior.

### Step 21

The user experiences communication behavior that results from the above control loop.

The user operates or rides in the autonomous mobile body while running applications that depend on network connectivity.

The input is the set of network and terminal behaviors established by the server and terminal in previous steps, and the output is the observable experience of stable connectivity, low latency, and reduced service interruption.

The user initiates actions such as starting navigation, streaming media, or remote monitoring, and observes that these services continue to function reliably even in areas with variable traffic demand, due to the server's optimized configuration and the terminal's adaptive control.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional communication networks rely on static or manually tuned configurations that do not adequately respond to rapid and fine-grained fluctuations in communication demand across different times and areas. Even where monitoring tools are deployed, operators typically must interpret disconnected telemetry streams, manually forecast demand, and handcraft quality-of-service and bandwidth allocation policies. This operator-driven workflow introduces latency, inconsistency, and configuration errors, and does not scale with the increasing complexity and dynamism of modern network topologies.

In attempts to automate parts of this workflow, known systems employ simple rule-based logic or basic prediction models. However, such systems are limited in their ability to integrate heterogeneous data sources including terminal-side position information, usage patterns, traffic measurements, and apparatus state information, and to convert the integrated data into coordinated control across a large number of communication apparatuses. As a result, these systems often fail to prevent localized congestion, service degradation, or under-utilization of network resources.

Furthermore, although generative artificial intelligence models and large language models have recently been used as advisory tools, they are typically accessed in an ad hoc manner through free-form prompts, without a structured integration with low-level telemetry, machine-learned demand forecasts, or automated configuration pipelines. This leads to outputs that are difficult to validate or to safely deploy to live communication apparatuses. At the same time, fault management is often handled separately from capacity planning, causing disjoint handling of demand prediction, configuration optimization, anomaly detection, and automatic recovery, and preventing the system from learning from its own past actions.

Accordingly, there is a need for an improved computer-implemented technique that: (i) systematically acquires and integrates terminal information, traffic information, and apparatus state information; (ii) performs machine-learning-based demand prediction at time-area granularity; (iii) combines such prediction with mathematical optimization or reinforcement learning to derive candidate network settings; (iv) uses a generative artificial intelligence model through structured prompt sentences to refine and synthesize network setting plans; (v) safely translates such plans into concrete control commands and applies them automatically to multiple communication apparatuses; (vi) continuously detects anomalies and performs automatic recovery; and (vii) feeds back the observed results and deviations into the machine learning algorithm and the generative artificial intelligence model to improve subsequent predictions and control. The technical problem is to provide improved computer technology at the server side, in the form of a coordinated, closed-loop system architecture that enhances accuracy, responsiveness, safety, and automation of network configuration and fault handling, thereby improving the operation of the networked computer system itself.

The specific processing by the specific processing unit 290 of the data processing device 12 in Example 2 is realized by the following means.

The present invention provides a server comprising a processor configured to acquire terminal information including position information and communication history information from one or more communication apparatuses, acquire traffic information and apparatus state information from one or more network monitoring apparatuses, and integrate the terminal information, the traffic information, and the apparatus state information to generate basic data for demand estimation for each time and each area; to execute demand prediction processing by a machine learning algorithm using the basic data for demand estimation to generate a demand prediction result representing future communication demand for each time and each area; to calculate, on the basis of the demand prediction result and network configuration information, candidate network settings including bandwidth allocation for each communication path, quality control parameters, and priority settings by mathematical optimization or reinforcement learning; to generate a prompt sentence including at least the demand prediction result and the candidate network settings, input the prompt sentence into a generative artificial intelligence model, and analyze a response obtained from the generative artificial intelligence model, the response being in a natural language format or a structured data format, to convert the response into setting information and control command sequences applicable to the communication apparatuses; to apply network settings to a plurality of communication apparatuses by using the setting information and the control command sequences through a remote operation communication protocol, acquire apparatus state information after the application, and verify consistency between the apparatus state information and the applied network settings; to monitor operation states of base stations and relay apparatuses on a continuous basis by using the traffic information and the apparatus state information, identify failure candidates by anomaly detection processing using statistical methods or machine learning, and execute an automatic recovery process including at least one of switching a communication path, restarting an interface, and rolling back a setting in accordance with an identified failure candidate; and to evaluate deviation between, on one hand, the automatically applied network settings and results of the automatic recovery process and, on the other hand, the demand prediction result, and store an evaluation result as learning data for the machine learning algorithm and the generative artificial intelligence model so as to improve accuracy of future demand prediction and network setting proposals. This enables the server to implement an integrated, closed-loop control architecture in which heterogeneous telemetry is fused for fine-grained demand prediction, optimized network settings are synthesized and refined through a generative artificial intelligence model using structured prompt sentences, validated configurations are automatically deployed and verified across multiple communication apparatuses, anomalies are autonomously detected and remediated, and observed outcomes are continuously fed back into the learning components, thereby improving the technical performance, adaptability, and robustness of the networked computer system.

The term “processor” refers to a hardware or virtual computation unit, such as a central processing unit, a graphics processing unit, or a programmable logic device, configured to execute instructions for performing data acquisition, analysis, prediction, optimization, and control operations.

The term “terminal information” refers to information obtained from one or more endpoint devices, the information including at least position information and communication history information associated with usage of a communication network by the endpoint devices.

The term “position information” refers to data representing a geographic location of a terminal, such as coordinates, area identifiers, or identifiers of access points or cells associated with the terminal.

The term “communication history information” refers to data representing past communication behavior of a terminal, including at least transmission volume, reception volume, connection duration, accessed services, and time stamps.

The term “communication apparatus” refers to a hardware element configured to participate in transmission or reception of communication data in a network, including at least base stations, routers, switches, relay apparatuses, and access points.

The term “network monitoring apparatus” refers to a hardware or software component configured to collect, aggregate, and provide traffic information and apparatus state information from one or more communication apparatuses.

The term “traffic information” refers to data representing a state of communication flows in a network, including at least throughput, packet counts, latency, loss rate, and protocol-specific metrics for one or more links, interfaces, or paths.

The term “apparatus state information” refers to data representing an operational condition of a communication apparatus, including at least resource utilization, error counters, alarm states, and interface statuses.

The term “basic data for demand estimation” refers to integrated data derived from terminal information, traffic information, and apparatus state information, organized per time and per area, and used as input to a machine learning algorithm for predicting future communication demand.

The term “time” refers to a temporal unit or time stamp representing when a communication activity, measurement, or prediction is observed, aggregated, or applied.

The term “area” refers to a spatial unit for aggregating and managing network data or settings, including at least a geographic region, coverage region of a base station, or logical region defined by network topology.

The term “demand prediction processing” refers to computation performed by use of a machine learning algorithm to estimate future communication demand on the basis of the basic data for demand estimation.

The term “demand prediction result” refers to an output of demand prediction processing that represents predicted communication demand for one or more future times and one or more areas.

The term “machine learning algorithm” refers to a computational procedure that learns relationships from data to generate a prediction or classification, including but not limited to regression models, neural networks, time-series models, or reinforcement learning models.

The term “network configuration information” refers to data describing a structure and current settings of a communication network, including at least topology, link capacities, routing policies, and quality-of-service parameters.

The term “candidate network settings” refers to one or more proposed configurations for a communication network, including at least bandwidth allocation for communication paths, quality control parameters, and priority settings, calculated on the basis of a demand prediction result and network configuration information.

The term “bandwidth allocation” refers to assignment of transmission capacity among different communication paths, areas, or traffic classes in a network.

The term “communication path” refers to a sequence of one or more links and communication apparatuses through which communication data can be transmitted from a source to a destination.

The term “quality control parameters” refers to parameters used to control quality of communication services, including at least delay targets, jitter targets, loss thresholds, queue sizes, and scheduling policies.

The term “priority settings” refers to parameters specifying ordering or relative importance of traffic classes or flows, used to determine how resources are assigned or queues are served.

The term “mathematical optimization” refers to computation that determines values of variables by maximizing or minimizing an objective function subject to constraints, including but not limited to linear, nonlinear, or integer optimization techniques.

The term “reinforcement learning” refers to a type of machine learning in which an agent learns a policy for selecting actions in an environment by receiving rewards or penalties based on outcomes of the actions.

The term “prompt sentence” refers to a structured or semi-structured natural-language or machine-readable expression that is input to a generative artificial intelligence model to specify a task, context, or constraints for generating an output.

The term “generative artificial intelligence model” refers to a machine learning model configured to generate new data, such as text or structured information, in response to an input, including at least sequence models, language models, or generative models trained on network-related or general data.

The term “natural language format” refers to a representation of information as one or more human-readable textual expressions.

The term “structured data format” refers to a representation of information in a machine-readable structure, including at least key-value pairs, tables, or hierarchical data such as markup or serialized object formats.

The term “setting information” refers to information representing specific values or policies for configuration of communication apparatuses, including at least quality-of-service parameters, bandwidth assignments, and control policies.

The term “control command sequences” refers to ordered sets of operations, instructions, or configuration commands executable by communication apparatuses to implement network settings.

The term “remote operation communication protocol” refers to a communication procedure used to configure or control communication apparatuses from a remote server, including at least command interfaces, management interfaces, or configuration protocols.

The term “base station” refers to a communication apparatus providing wireless access to terminals within a coverage area.

The term “relay apparatus” refers to a communication apparatus that transfers communication data between different parts of a network, including at least routers, switches, or intermediate forwarding devices.

The term “operation state” refers to a condition in which a communication apparatus or network element is functioning, degraded, or failed, as indicated by one or more apparatus state information elements.

The term “failure candidate” refers to an apparatus, interface, or path that is deemed likely to be in a faulty or abnormal condition based on anomaly detection processing applied to traffic information and apparatus state information.

The term “anomaly detection processing” refers to computation that identifies deviations from expected behavior in traffic information or apparatus state information using statistical methods, rule-based methods, or machine learning techniques.

The term “automatic recovery process” refers to a sequence of operations automatically executed by a server to mitigate or resolve a detected failure candidate, including at least switching a communication path, restarting an interface, or rolling back a setting.

The term “switching a communication path” refers to changing routing or forwarding behavior so that communication traffic is transferred over an alternative path instead of a current path.

The term “restarting an interface” refers to a control action that disables and then re-enables a communication interface on a communication apparatus to restore normal operation.

The term “rolling back a setting” refers to a control action that reverts one or more configuration parameters of a communication apparatus from a current value to a previous or default value.

The term “evaluation result” refers to information indicating a degree of deviation or agreement between predicted or planned behavior and actually observed behavior, including at least error measures, performance metrics, or classification outcomes.

The term “learning data” refers to data used to train or update a machine learning algorithm or a generative artificial intelligence model, including at least input features, labels, rewards, and evaluation results.

The term “network setting proposals” refers to candidate configurations or policies for a communication network generated by a machine learning algorithm, optimization method, or generative artificial intelligence model for potential application to communication apparatuses.

The server, the terminal, and the user cooperate to implement embodiments of the present invention as described below. In the following description, the server denotes a data processing apparatus having at least one processor, a memory, a non-volatile storage, and network interfaces; the terminal denotes a user device such as a smartphone, tablet, or personal computer; and the user denotes a human operator or end-user who utilizes communication services or supervises network operations.

The server executes a computer program stored in the memory to realize the functions defined in the claims. The server uses general-purpose hardware such as a central processing unit (CPU), a graphics processing unit (GPU), and a network interface controller. In one embodiment, the server includes multiple multi-core CPUs, one or more GPUs, solid-state drives for storing large volumes of telemetry data, and high-speed network interfaces connected to communication apparatuses and monitoring apparatuses.

The server executes system software such as an operating system, a database management system, and a container runtime, and executes application software implemented, for example, using a programming language and machine learning libraries. In one embodiment, the server uses a relational or time-series database to store traffic information, apparatus state information, and terminal information. The server uses a data processing framework to perform batch and streaming processing, and uses a machine learning library to implement neural network models and optimization algorithms. The server may execute network automation tools to apply control command sequences to routers, switches, base stations, and other communication apparatuses.

The terminal acquires position information and communication history information using built-in sensors and communication stacks. The terminal reads GPS coordinates using a position sensor, and obtains identifiers such as cell identifiers and access point identifiers from a cellular modem and a wireless local area network module. The terminal measures transmission and reception volumes, records used application categories, and detects connection durations using operating system APIs. The terminal periodically transmits such terminal information to the server through a secure communication channel such as an HTTPS connection. This terminal behavior enables the server to obtain fine-grained, real-time usage and location data that cannot be practically collected by human operators, thereby contributing to a more accurate and timely representation of network demand.

The user uses the terminal to connect to the network and to generate traffic patterns such as video streaming, web browsing, and real-time communications. The user may also operate a management console provided by the server in order to input administrative instructions or to provide a prompt sentence to a generative AI model. By issuing such prompt sentences, the user specifies tasks such as “Predict the network demand in Tokyo for the next 24 hours and propose optimal bandwidth settings per district.” or “Generate a QoS policy that guarantees smooth video streaming at the event venue in Osaka from 18:00 to 21:00.” The server receives these prompt sentences and further uses them as structured inputs to a generative AI model together with machine-readable context data, thereby extending the capabilities of conventional command-line or graphical configuration tools.

The server acquires traffic information and apparatus state information from a network monitoring apparatus. The network monitoring apparatus may be implemented as a monitoring server that polls communication apparatuses using network management protocols, receives notification messages such as traps and logs, and stores raw measurements. The server periodically queries the monitoring apparatus by way of an application programming interface to obtain, for each communication apparatus and interface, parameters including throughput, packet loss, delay, resource utilization, error counters, and alarm states. The server may also receive streaming telemetry from communication apparatuses using a subscription-based protocol. These measurements are normalized into a unified data structure that associates each measurement with a device identifier, interface identifier, metric type, value, timestamp, and area identifier.

The server integrates terminal information, traffic information, and apparatus state information into basic data for demand estimation. The server uses a feature extraction module that maps position information to area identifiers using a geographic index or a cell-to-area lookup table.

The server aggregates communication history information over predetermined time windows such as 5 minutes, 15 minutes, or 1 hour, and calculates features such as the number of active terminals per area, total throughput per area, ratio of traffic categories, and the variance of throughput over the time window. The server further combines these features with apparatus state information that indicates congestion status, resource utilization, or error conditions for communication apparatuses serving each area. The resulting integrated dataset forms multidimensional time-series data, where each record corresponds to a specific time, area, and set of features capturing both user-side and network-side conditions.

The server stores the basic data for demand estimation in a database using a defined data schema.

In one embodiment, each record includes a timestamp normalized to a reference time zone, an area identifier, and a vector of numeric features such as active user count, average throughput, peak throughput, percentage of video traffic, percentage of real-time communication traffic, queue utilization, and error rate. The server indexes these records by time and area, which enables efficient retrieval of sequences of feature vectors required by the machine learning algorithm. This specific data structure allows the demand prediction algorithm to consider spatiotemporal correlations and apparatus state effects in a consistent manner, thereby improving prediction accuracy and reducing the need for ad hoc pre-processing by human operators.

The server executes demand prediction processing by a machine learning algorithm using the basic data for demand estimation. In one embodiment, the server uses a neural network model with a sequence-processing architecture, such as a recurrent neural network, a long short-term memory (LSTM) network, a gated recurrent unit (GRU) network, or a transformer-based model.

The server constructs input tensors from sequences of past feature vectors, for example, using the last 7 days of data for each area with a fixed time resolution. The server normalizes each feature by applying scaling parameters derived from historical statistics. The server inputs these tensors into the neural network model to obtain predicted values for future time steps, such as the expected throughput and active user count for each area for the next 24 hours at 15-minute intervals.

The server trains the neural network model using training data that includes historical basic data for demand estimation and ground truth demand values. The server defines a loss function such as mean squared error or mean absolute error between predicted and actual demand. The server uses an optimization algorithm such as stochastic gradient descent or an adaptive optimization method to update model parameters, including weights and biases in each layer. The server may apply regularization techniques such as dropout or weight decay and may perform data augmentation by adding noise or introducing synthetic demand patterns to improve robustness.

The server periodically retrains or fine-tunes the model using newly collected data to adapt to changes in user behavior and network characteristics.

The server differs from human operators in that it applies the machine learning algorithm deterministically and consistently across all areas and time periods, uses multidimensional feature vectors beyond what can be easily tracked manually, and processes large volumes of data much faster than human capability. This leads to reduced prediction error, faster adaptation to demand changes, and elimination of operator-induced inconsistencies, thereby improving the technical performance of the networked computer system.

The server calculates candidate network settings based on the demand prediction result and network configuration information. The server maps each area's predicted demand to specific communication paths and interfaces using a topology database that describes links between communication apparatuses, capacity constraints, and coverage relationships. The server constructs an optimization problem in which decision variables represent, for example, bandwidth allocations to logical traffic classes, per-interface rate limits, and scheduling weights for queues. The server defines an objective function that penalizes predicted congestion and under-utilization while respecting constraints such as maximum link capacity, minimum guaranteed bandwidth for critical services, and fairness between areas. The server uses a mathematical optimization solver or a reinforcement learning agent to find values of the decision variables that optimize the objective function under the constraints.

In one embodiment, the server formulates a linear or mixed-integer programming problem where each decision variable corresponds to a specific configurable parameter on one or more communication apparatuses. The server uses a solver to compute optimal or near-optimal values.

In another embodiment, the server uses a reinforcement learning agent that observes the demand prediction and current configuration state, selects configuration actions, and receives rewards proportional to achieved network performance metrics such as throughput and latency. The server trains the reinforcement learning agent offline using a network simulator or historical logs, and applies the trained policy online to compute candidate network settings. By using such algorithmic optimization, the server can explore a larger configuration space than a human operator and can discover non-intuitive settings that reduce congestion or improve quality-of-service, thereby improving overall network efficiency.

The server generates a prompt sentence that includes at least the demand prediction result and the candidate network settings and inputs the prompt sentence into a generative AI model. The generative AI model may be implemented as a large language model based on a transformer architecture, trained on textual data and possibly fine-tuned on network configuration documents and telemetry descriptions. The server constructs a prompt sentence that embeds structured information converted to natural language, such as:

“Based on the following predicted traffic for Tokyo for the next 24 hours per district, and the following candidate bandwidth allocations and QoS weights for each router interface, generate a safe and efficient network configuration plan, including concrete command sequences for the devices, ensuring that video streaming traffic in the Shinjuku area between 18:00 and 21:00 has low latency and that failure scenarios are covered.”

The server may also use other example prompt sentences, such as:

“Predict the network demand in Tokyo for the next 24 hours and propose optimal bandwidth settings per district.”

“Generate a QoS policy that guarantees smooth video streaming at the event venue in Osaka from 18:00 to 21:00.”

“Analyze the last 7 days of traffic in Nagoya and recommend capacity upgrades for base stations that are likely to become congested within the next month.”

“Identify devices that show early signs of hardware failure and propose automated remediation steps.”

The server provides the prompt sentence and relevant context data to the generative AI model through an inference application programming interface. The server receives a response from the generative AI model in natural language or structured form. The response may include proposed policies, explicit device commands, parameter settings, and failure-handling procedures. The server parses the response by applying rule-based extraction, pattern matching, or parser modules that convert textual descriptions to machine-readable configuration templates. The server then converts the extracted information into setting information and control command sequences that can be directly applied to communication apparatuses.

The server implements specific rules and safety policies that restrict the generative AI model output. For example, the server enforces that certain critical traffic classes always have a minimum bandwidth allocation and that commands that disable security features are rejected.

The server compares the generated settings against a baseline configuration, checks for conflicts, and rejects or modifies portions of the proposed configuration that violate technical constraints.

This constrained use of the generative AI model ensures that the system does not merely automate human drafting but instead uses the model as a component within a deterministic, verifiable control pipeline, thereby improving reliability and safety of network operations.

The server applies the resulting control command sequences to communication apparatuses via a remote operation communication protocol. The server establishes secure management sessions with routers, switches, base stations, and other communication apparatuses using management interfaces. The server transmits device-specific commands that correspond to the optimized settings and generative AI-derived configurations, such as commands setting bandwidth limits, priority queues, scheduling policies, or failover rules. The communication apparatuses update their internal forwarding tables, queue parameters, and scheduling algorithms accordingly. The server then retrieves apparatus state information indicating the applied settings and current performance metrics to verify that the intended configuration has been correctly applied. By programmatically controlling device-level configuration, the server directly affects real-world packet forwarding behavior, reducing congestion, lowering latency for critical traffic, and improving resource utilization.

The server continuously monitors operation states of base stations and relay apparatuses using traffic information and apparatus state information. The server executes anomaly detection processing to identify failure candidates. In one embodiment, the server maintains a statistical baseline for each metric and applies statistical tests to detect deviations beyond a threshold. In another embodiment, the server uses a machine learning model trained for anomaly detection, such as an autoencoder or a one-class classifier that reconstructs normal behavior and flags deviations as anomalies. The server considers combined patterns across multiple metrics and devices to identify correlated failures, for example, by using graph-based models or clustering techniques. When the server detects a failure candidate, such as an interface that frequently toggles state or a device whose error counters spike, the server selects and executes an automatic recovery process.

The automatic recovery process includes operations such as switching traffic to an alternative communication path, restarting an interface, or rolling back a recently applied setting. The server determines which recovery action to take by matching the failure candidate with pre-defined recovery rules, possibly refined by a reinforcement learning policy. The server sends control commands to reconfigure routing, enable or disable interfaces, or revert configuration parameters to a previously stored state. The communication apparatuses perform the requested operations and report new apparatus state information. This closed-loop failure handling reduces restoration time and decreases human intervention, and because it is driven by formal models and rules rather than ad hoc human judgment, it reduces configuration errors and inconsistent responses to failures.

The server evaluates deviation between the automatically applied network settings and results of the automatic recovery process on one hand and the demand prediction result on the other hand.

The server quantifies this deviation using metrics such as difference between predicted and observed throughput, frequency of congestion events, or number of anomalies not prevented by the applied settings. The server stores the evaluation result as learning data for both the demand prediction model and the generative AI model. The server uses these evaluation results to update model parameters, adjust loss functions, or modify reinforcement learning reward functions, thereby biasing future learning toward configurations that produce better network outcomes.

Over time, this feedback mechanism improves prediction accuracy, reduces unnecessary configuration changes, and shortens failure recovery times.

The described embodiments improve computer technology itself, rather than merely automating a business process. Specifically, the server introduces novel internal data structures that fuse terminal and network telemetry at high temporal and spatial resolution, uses specialized machine learning architectures tuned to those data structures, and combines predictive modeling with formal optimization and constrained generative modeling. This combination reduces computational complexity by focusing optimization on high-impact parameters, improves accuracy by incorporating richer contextual features, and decreases communication overhead by preemptively allocating resources in a way that reduces retransmissions and congestion-induced backoffs. Furthermore, by embedding a generative AI model into a controlled, structured workflow with prompt sentences and safety checks, the server leverages generative capabilities to search a vast configuration space but constrains deployment to configurations that satisfy algorithmically verifiable criteria. This is distinct from manual drafting or naive automation because it uses AI models to explore configurations beyond human-designed heuristics while maintaining deterministic enforcement of technical constraints.

Alternative embodiments may vary the specific architectures of the machine learning and generative AI models, the types of optimization algorithms, or the remote operation communication protocols, while preserving the core data flows and control logic. For example, the server may use a convolutional neural network for modeling spatial correlations between areas, may use a different generative model architecture for producing configuration templates, or may use different management protocols for interacting with communication apparatuses. The server may also support different granularities of time and area segmentation and may integrate additional telemetry sources such as environmental sensors or application-layer logs. In all such embodiments, the server continues to operate as the central coordinating entity that acquires, integrates, predicts, optimizes, generates, verifies, and applies network configurations in a closed-loop manner that enhances the technical performance of the overall networked computer system.

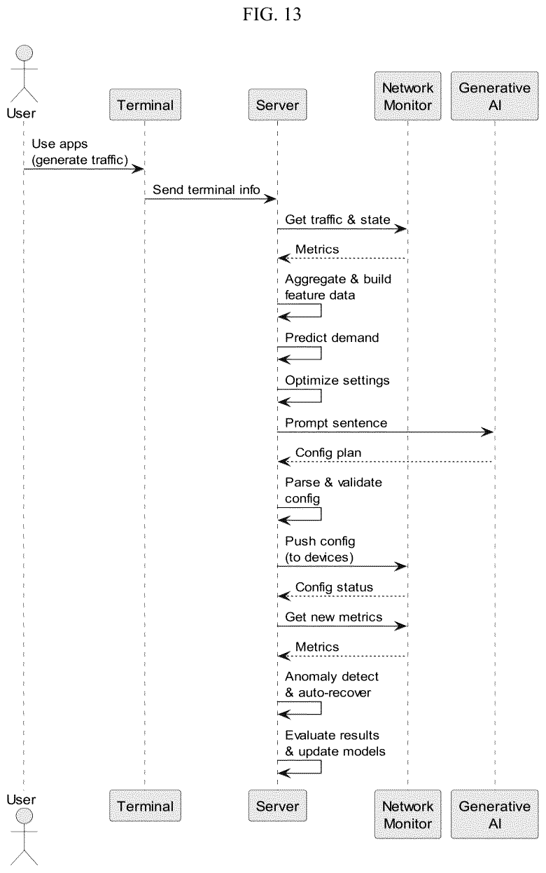

The following describes the processing flow using FIG. 13.

### Step 1

The terminal acquires position information and communication history information and transmits terminal information to the server.

The terminal uses a GPS module and communication stacks as input sources and obtains GPS coordinates, cell identifiers, access point identifiers, transmitted bytes, received bytes, application categories, and connection durations as input data. The terminal performs data processing in which it reads raw sensor values and network statistics from the operating system, converts them into normalized units (for example, decimal degrees for latitude/longitude and kilobits per second for throughput), and aggregates usage over a fixed interval such as 60 seconds. The terminal then generates, as output, a terminal information record that includes a terminal identifier, timestamp, position information, and communication history information, and sends this record to the server over a secure communication channel.

### Step 2

The server receives the terminal information and stores normalized terminal usage data.

The server takes, as input, the terminal information records transmitted from one or more terminals via a network interface. The server performs data validation (schema checking, value range checking, and authentication token verification), converts timestamps to a unified time zone, and maps raw identifiers to internal identifiers. The server then performs data processing in which it parses the received messages, extracts fields such as terminal identifier, latitude, longitude, and throughput, and normalizes units and formats. As output, the server writes structured terminal usage entries into a terminal usage table in a database, each entry including a time key, a terminal key, and numeric feature values.

### Step 3

The server acquires traffic information and apparatus state information from a network monitoring apparatus and stores normalized device metrics.

The server uses an application programming interface to obtain, as input, traffic measurement records and apparatus state records from the network monitoring apparatus. The input includes device identifiers, interface identifiers, throughput, packet counts, delay, error counters, CPU usage, memory usage, and alarm states. The server performs data processing in which it parses protocol messages, converts counters to rates by dividing by the measurement interval, and associates each measurement with a standardized metric type. The server then outputs normalized device metric entries and stores them in a device metrics table in the database, indexed by device identifier, interface identifier, and timestamp.

### Step 4

The server associates terminal information with areas and aggregates usage per area and time slot to generate basic data for demand estimation.

The server takes, as input, the terminal usage entries and a mapping between position information (coordinates, cell identifiers, and access point identifiers) and area identifiers. The server performs data processing in which it converts coordinates into area identifiers using a geographic index, joins terminal usage entries with area identifiers, groups entries by area and by fixed time windows (for example, 15-minute slots), and calculates aggregated features. The server calculates, for each area and time slot, the number of active terminals, total throughput, average throughput per terminal, and ratios of different application categories. As output, the server generates area-level usage feature records and stores them as basic data for demand estimation in a time-series table keyed by area and time.

### Step 5

The server integrates aggregated usage features with device metrics and generates multi-dimensional feature vectors per area and time.

The server uses, as input, the area-level usage feature records, the normalized device metric entries, and a topology mapping between areas and communication apparatuses. The server performs data processing in which it joins area usage data with device metrics of apparatuses serving each area, aligns timestamps by rounding or interpolation, and constructs feature vectors that include both user-side metrics (such as active user count and video traffic ratio) and network-side metrics (such as interface utilization and error rates). The server outputs integrated feature vectors for each area and time and stores them as basic data for demand estimation that will be provided to a machine learning algorithm.

### Step 6

The server constructs time-series input tensors for a demand prediction model using the integrated feature vectors.

The server takes, as input, the integrated feature vectors for a selected historical period, such as the last 7 days, for each area. The server performs data processing in which it normalizes each feature by subtracting a mean and dividing by a standard deviation, and slides a fixed-length time window over the sequence of feature vectors to form sequences of consecutive time steps. The server reshapes these sequences into multi-dimensional arrays representing batches of samples with dimensions corresponding to batch size, time steps, and feature dimension. As output, the server generates normalized time-series input tensors and supplies them to a machine learning module implementing the demand prediction model.

### Step 7

The server executes demand prediction processing by a machine learning algorithm and generates demand prediction results.

The server uses, as input, the time-series input tensors and model parameters of a neural network-based demand prediction model. The server performs data processing in which it propagates the input tensors through layers of the model, such as recurrent layers or transformer layers, applies activation functions, and computes output vectors representing predicted demand values for future time steps for each area. The server may perform multiple forward passes if the model generates probabilistic predictions. The server then de-normalizes the predicted values back to physical units such as bits per second and number of active users. As output, the server generates demand prediction results indicating expected demand per area and time and writes them into a demand prediction table in the database.

### Step 8

The server maps the demand prediction results to communication paths and constructs an optimization problem for candidate network settings.

The server takes, as input, the demand prediction results and network configuration information describing topology, link capacities, and current quality-of-service policies. The server performs data processing in which it maps each area's predicted demand to specific communication paths and interfaces serving that area using topology relations, and calculates required bandwidth per path and per traffic class. The server constructs a mathematical model by defining decision variables for bandwidth allocation, queue weights, and rate limits, and formulates an objective function and constraints based on capacity limits and policy rules. As output, the server creates an optimization problem instance that fully specifies coefficients, constraints, and objective parameters for use by an optimization solver.

### Step 9

The server solves the optimization problem and generates candidate network settings.

The server uses, as input, the optimization problem instance defined in the previous step. The server performs data processing in which it calls an optimization solver or reinforcement learning agent, iteratively updates candidate solutions by evaluating feasibility and objective value, and converges to a solution that satisfies constraints to within a specified tolerance. The server then transforms numerical solutions of decision variables into network setting parameters such as bandwidth limits, minimum guarantees, queue scheduling weights, and priority levels for different traffic classes on each interface. As output, the server generates candidate network settings, each associated with a particular communication apparatus and interface, and stores them in a candidate configuration table.

### Step 10

The server generates a prompt sentence that includes the demand prediction results and candidate network settings for input to a generative AI model.

The server takes, as input, the demand prediction results, the candidate network settings, and context information such as service-level requirements and recent anomaly history. The server performs data processing in which it serializes structured information into textual descriptions, arranges them according to a predetermined template, and constructs a prompt sentence that describes predicted demand, current and candidate settings, and constraints. The server inserts explicit instructions requesting the generative AI model to propose a network setting plan and concrete command sequences. As output, the server produces a complete prompt sentence in natural language suitable for input to the generative AI model.

### Step 11

The server sends the prompt sentence to the generative AI model and receives a proposed network setting plan.

The server uses, as input, the prompt sentence generated in the previous step. The server performs data processing in which it transmits the prompt sentence to the generative AI model through an inference interface, waits for the model to process the input, and receives a textual or structured response from the model. The response may include explanations, recommended bandwidth allocations, quality-of-service policies, and low-level command templates. As output, the server obtains a raw network setting plan expressed in natural language or structured form and stores it in a response object for further parsing.

### Step 12

The server parses the network setting plan from the generative AI model and converts it into device-specific setting information and control command sequences.

The server takes, as input, the raw network setting plan received from the generative AI model and a set of parsing rules and templates. The server performs data processing in which it applies pattern matching and parsing rules to identify parameter values, interface identifiers, traffic class names, and command patterns, and maps these elements to device-specific configuration formats.

The server checks the extracted settings against safety and policy rules and discards or adjusts portions that violate constraints. As output, the server generates device-specific setting information objects and ordered control command sequences that can be executed on corresponding communication apparatuses.

### Step 13

The server applies the control command sequences to communication apparatuses via a remote operation communication protocol.

The server uses, as input, the control command sequences and connection information for target communication apparatuses. The server performs data processing in which it establishes secure management sessions with each apparatus, sends commands in the appropriate syntax, and monitors acknowledgments and error codes. The server may apply commands in a transactional manner by backing up previous configurations and applying changes in a staged order. As output, the server causes each communication apparatus to update internal configuration states, such as bandwidth limits and queue settings, and records the execution status and results in a configuration log.

### Step 14

The server acquires post-application apparatus state information and verifies consistency with the applied network settings.

The server takes, as input, the execution status of control command sequences and fresh apparatus state information obtained from the network monitoring apparatus or directly from devices. The server performs data processing in which it compares reported configuration parameters and performance metrics against the intended network settings, checks for mismatches or failed commands, and computes indicators of configuration consistency. As output, the server produces verification results that indicate whether the configuration has been successfully applied and whether adjustments are needed, and stores these results for subsequent analysis.

### Step 15

The server performs anomaly detection on traffic information and apparatus state information to identify failure candidates.

The server uses, as input, time-series traffic information, apparatus state information, and optionally baseline patterns learned by an anomaly detection model. The server performs data processing in which it calculates statistical measures such as moving averages and variances, feeds sequences of metrics into anomaly detection algorithms, and computes anomaly scores for each device, interface, and path. If an anomaly score exceeds a threshold, the server marks the associated element as a failure candidate. As output, the server generates a list of failure candidates with associated metrics and anomaly scores and stores them in a failure candidate table.

### Step 16

The server selects and executes automatic recovery actions for identified failure candidates.

The server takes, as input, the list of failure candidates and a rule base or policy specifying recovery procedures. The server performs data processing in which it matches the type and location of each failure candidate with corresponding recovery rules, such as switching to a backup path, restarting an interface, or rolling back recent configuration changes. The server then generates specific control command sequences for the selected recovery action and sends them to the affected communication apparatuses through the remote operation protocol. As output, the server modifies network paths and device states to restore normal operation and records the details and outcomes of the automatic recovery actions.

### Step 17

The server evaluates deviations between predicted demand, applied network settings, and actual network behavior.

The server uses, as input, the demand prediction results, the applied network settings, observed traffic information, and results of automatic recovery actions. The server performs data processing in which it computes differences between predicted and observed traffic metrics per area and time, measures the frequency and severity of congestion events, and assesses how effectively the applied settings prevented or mitigated anomalies. The server calculates evaluation metrics such as mean prediction error, configuration success rate, and reduction in anomaly occurrence. As output, the server produces evaluation records that quantify deviations and performance, and stores them as feedback data.

### Step 18

The server updates learning data for the demand prediction model and the generative AI model using the evaluation records.

The server takes, as input, the evaluation records, the original basic data for demand estimation, and logs of prompt sentences and generative AI model responses. The server performs data processing in which it associates each prediction and configuration decision with subsequent performance outcomes, labels training examples with error measures or rewards, and constructs updated training datasets. The server then initiates or schedules retraining or fine-tuning of the demand prediction model by updating weights to reduce prediction error and adjusts fine-tuning data for the generative AI model to better align its outputs with configurations that produced favorable outcomes. As output, the server generates updated model parameters and adjusted training datasets, enabling improved accuracy and robustness in subsequent executions of the program.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In modern communication networks, the control of radio and transport resources is still largely based on static parameters, coarse-grained forecast models, and manually crafted rules. Conventional systems typically rely on fixed configuration templates, simple threshold checks, or offline capacity planning tools that are not tightly integrated with real-time data from end terminals, base stations, and users. As a result, these systems frequently fail to react adequately to rapid changes in spatial and temporal network demand, leading to over-provisioning in low-demand regions, congestion in high-demand regions, and increased latency and packet loss for latency-sensitive applications.

Furthermore, conventional monitoring frameworks focus on detecting equipment faults by simple metric thresholding and raising alarms to human operators. The actual recovery actions, such as restarting devices, reapplying configurations, or rerouting traffic, are generally performed manually or through rigid scripts that are not adaptive to the current network state. This causes prolonged downtime, inconsistent recovery quality, and high operational cost, especially in large-scale heterogeneous networks including many base stations and other communication devices.

In addition, existing network control techniques do not utilize high-level machine learning models, such as generative AI models that can interpret prompt sentences describing complex network states and objectives, as a central component of the control plane. Consequently, such techniques cannot flexibly synthesize configuration strategies based on multi-dimensional context information, including predicted demand, resource constraints, device health, and user-centric indicators such as emotion or quality of experience.

Traditional systems also treat user feedback as a coarse, after-the-fact signal (for example, customer complaints) rather than a continuous input to the control loop. While some systems may log application-level metrics, they rarely incorporate fine-grained emotional states derived from sensor data (such as appearance and voice signals) into the real-time adjustment of network paths and bandwidth allocations. This results in a gap between low-level network metrics and the actual user-perceived quality, and prevents the network from proactively mitigating user frustration or stress caused by degraded connectivity.

Moreover, known solutions for distributed event handling, such as base station failures, do not coordinate with higher-level optimization logic or generative AI models. They lack an integrated mechanism for encoding the current fault status and available recovery options as a structured prompt, obtaining a dynamically generated repair procedure from an AI model, and executing that procedure in a closed loop. Thus, the system cannot leverage the flexibility and reasoning capability of generative AI to improve fault recovery strategies over time.

There is therefore a need for improved computer technology that tightly integrates: (i) demand prediction based on terminal location and communication history, (ii) network configuration synthesis via generative AI models driven by prompt sentences encoding current state and constraints, (iii) automatic fault detection and repair for communication devices, and (iv) emotion-aware optimization of communication quality and service provision. Such technology should transform the processor, memory, and network interfaces of a server system into a more efficient and adaptive platform for real-time network control, reduce the computational and operational overhead required for manual configuration and troubleshooting, and improve both objective network performance and user-perceived quality of experience.

The specific processing by the specific processing unit 290 of the data processing device 12 in Application Example 2 is realized by the following means.

The present invention provides a server comprising a processor and a memory storing instructions, wherein the processor is configured to execute the instructions to collect position information acquired by positioning components of mobile terminals together with communication history information, aggregate and statistically process the collected information to generate demand prediction information indicating communication demand for each time period and each area, generate a prompt sentence as text data including at least the demand prediction information and network resource constraint information, input the prompt sentence to a generative AI model, obtain, from the generative AI model, a network setting plan including, for each time period and each area, at least one of bandwidth allocation, quality control conditions, and route control conditions, and automatically update operation settings of communication devices based on the network setting plan; to continuously accumulate performance information and operation information of the communication devices acquired from monitoring measurement mechanisms and monitoring programs, execute threshold determination or anomaly detection processing on the performance information and the operation information to detect a failure event, and automatically execute a repair process including at least one of a restart process and a configuration reapplication process on the communication device for which the failure event is detected, by remote operation using a configuration management program; to acquire appearance information and voice information of a user from imaging mechanisms and audio acquisition mechanisms, input the appearance information and the voice information to an emotion recognition model to specify an emotional state of the user, and adjust communication quality by dynamically changing at least one of a communication path and a bandwidth allocation for the user based on the emotional state and communication quality information; to generate, as a prompt sentence, state information including at least the demand prediction information and the emotional state, input the prompt sentence to the generative AI model, obtain, from the generative AI model, a network setting plan and a service provision policy that take the emotional state into account, and perform communication control and service provision in accordance with the network setting plan and the service provision policy; and to generate notification data including state information relating to occurrence of the failure event or a repair result, transmit the notification data to the mobile terminal via a notification delivery mechanism, and execute at least one of the restart process and a network setting change process for the communication device based on a remote operation instruction received from the mobile terminal. This enables the server to function as an improved network control platform that transforms heterogeneous monitoring data, predicted demand, and user emotion signals into concrete network configurations via generative AI models, thereby reducing manual configuration load, shortening fault recovery time, and adaptively optimizing communication quality and service delivery in response to both objective network conditions and user-centric states.

The term “processor” refers to one or more hardware processing units, such as a central processing unit or other arithmetic and logic circuitry, configured to execute instructions stored in a memory to perform data collection, analysis, control, and communication operations.

The term “memory” refers to one or more non-transitory computer-readable storage media, such as semiconductor memory devices or magnetic storage devices, that store instructions and data for execution and use by the processor.

The term “mobile terminal” refers to any portable communication equipment used by a user, such as a handheld computing device, a portable communication device, or an in-vehicle communication device, that is capable of wireless communication and location acquisition.

The term “positioning device” refers to any hardware and associated software configured to determine a geographical position of a mobile terminal, such as a satellite-based positioning receiver, a terrestrial positioning module, or a hybrid positioning mechanism.

The term “position information” refers to data indicating a geographical location of a mobile terminal, including at least one of coordinates, an area identifier, or a cell identifier associated with a communication area.

The term “communication history information” refers to data representing past communication behavior of a mobile terminal or a user, including at least one of traffic volume, session count, application type, connection duration, and quality metrics over time.

The term “demand prediction information” refers to data generated by predictive processing that indicates an expected communication demand, such as expected traffic volume or number of active sessions, for each time period and each area.

The term “network resource constraint information” refers to data specifying limitations or conditions on use of communication resources, including at least one of maximum total bandwidth, capacity of a communication device, and permitted quality of service levels.

The term “prompt sentence” refers to text data that encodes state information, constraints, objectives, or context in natural language or structured text format and is provided as input to a generative AI model to obtain configuration or control output.

The term “generative AI model” refers to a machine learning model configured to generate output data, such as configuration strategies or control plans, based on input data including at least a prompt sentence, where the model is trained using data-driven learning techniques.

The term “network setting plan” refers to a set of configuration data derived from the generative AI model or other computation, indicating at least one of bandwidth allocation, quality control conditions, and route control conditions for communication devices in specified time periods and areas.

The term “bandwidth allocation” refers to configuration data that determines an amount or proportion of available communication capacity assigned to at least one of a communication device, a communication path, a user, or a service.

The term “quality control conditions” refers to configuration parameters that define quality of service or quality of experience behavior, including at least one of priority classes, delay targets, jitter constraints, and packet loss thresholds.

The term “route control conditions” refers to configuration parameters that determine selection or modification of communication paths, including at least one of routing rules, path weights, and handover thresholds between communication areas.

The term “communication device” refers to any hardware element that participates in data transmission or reception within a communication network, including at least one of a base station, a relay device, a gateway, and a routing device.

The term “monitoring measurement mechanism” refers to any combination of hardware and software configured to obtain performance information or operation information from a communication device, including measurement agents, probes, and network management interfaces.

The term “monitoring program” refers to software executed by a processor that periodically or continuously collects, stores, and evaluates performance information and operation information of communication devices for supervision and alarm generation.

The term “performance information” refers to data representing operating characteristics of a communication device, including at least one of processor utilization, memory usage, traffic counters, error counts, and delay measurements.

The term “operation information” refers to data representing a state of a communication device, including at least one of availability, reachability, configuration status, and operational mode.

The term “failure event” refers to a condition in which a communication device or a part of a communication network deviates from an expected operating state, including at least one of service outage, severe degradation, or abnormal resource utilization.

The term “threshold determination” refers to processing in which current performance information or operation information is compared with predetermined threshold values to determine whether a failure event or abnormal state has occurred.

The term “anomaly detection processing” refers to analysis that identifies abnormal patterns or deviations in performance information or operation information relative to normal baselines or models.

The term “configuration management program” refers to software that performs remote management of communication devices, including at least one of distributing configuration data, executing remote commands, and orchestrating device operations.

The term “restart process” refers to a series of operations that stop and subsequently start a communication device or its software components to restore normal operation.

The term “configuration reapplication process” refers to a series of operations that reapply or reload configuration data to a communication device to restore or correct its settings.

The term “image acquisition device” refers to hardware and associated software configured to capture visual information of a user or an environment, such as an imaging sensor or a camera module.

The term “voice acquisition device” refers to hardware and associated software configured to capture audio information, such as a microphone or an audio input interface.

The term “appearance information” refers to data obtained from an image acquisition device representing at least part of a user's face, body, or posture for analysis of emotional or behavioral state.

The term “voice information” refers to audio data representing a user's speech or vocal sound for analysis of emotional or behavioral state.

The term “emotion recognition model” refers to a machine learning model configured to classify or estimate an emotional state of a user based on at least one of appearance information and voice information.

The term “emotional state” refers to information indicating a psychological condition of a user, such as stress, frustration, satisfaction, joy, or neutrality, inferred from sensor data or other indicators.

The term “communication quality information” refers to data that characterizes quality of communication experienced by a user or a service, including at least one of throughput, latency, jitter, packet loss, and error rates.

The term “communication path” refers to a logical or physical route through which data is transmitted between a mobile terminal and another endpoint in a communication network.

The term “state information” refers to aggregated data representing a current or predicted status of at least part of a communication system, including at least one of demand prediction information, emotional state, performance information, and operation information.

The term “service provision policy” refers to a set of rules or strategies that specify how services are to be offered to a user, including at least one of priority of service, type of promotion, and selection of communication resources.

The term “notification data” refers to data representing information regarding a system event, such as occurrence of a failure event or a result of a repair process, intended to be delivered to a mobile terminal for display or further action.

The term “notification delivery mechanism” refers to a communication arrangement that delivers notification data from a server to a mobile terminal, including at least one of a push notification service, a messaging service, and a signaling protocol.

The term “remote operation instruction” refers to a command or request transmitted from a mobile terminal to a server, specifying at least one control action to be applied to a communication device, such as a restart or configuration change.

The term “control plan” refers to a set of actions or configuration changes proposed by a generative AI model or other logic, which specifies how communication devices or network settings should be adjusted over time and space.

The term “bypass route setting process” refers to a process in which routing or path selection in a communication network is modified to direct traffic around a malfunctioning or degraded communication device.

In one embodiment, a server, a plurality of terminals, and a plurality of communication devices such as base stations and routing devices are interconnected via a packet-switched network. The server includes at least one processor and at least one non-transitory memory. The memory stores instructions that, when executed by the processor, cause the server to perform the data collection, analysis, control, and notification operations described below.

A terminal includes a processing unit, a memory, a positioning device, an image acquisition device, a voice acquisition device, and a wireless communication interface. The terminal may be implemented as a handheld communication device, a wearable device, or an in-vehicle communication unit. The positioning device may include a satellite-based positioning receiver.

The image acquisition device may include a camera module. The voice acquisition device may include a microphone. The wireless communication interface may support cellular communication, wireless local area network communication, or another wireless communication system.

A user carries or operates the terminal during normal activities. The terminal periodically acquires position information from the positioning device, such as latitude, longitude, and associated timestamps. The terminal further collects communication history information, such as transmitted and received data volumes, session counts, and application identifiers, by monitoring local network stack statistics. The terminal may compress, encrypt, and transmit the position information and the communication history information to the server using a secure transport protocol.

The server receives the position information and the communication history information from a plurality of terminals. The server stores the received information in data structures such as relational tables or columnar storage structures. For example, the server maintains a “locations” table containing terminal identifiers, area identifiers derived from coordinates, and timestamps, and a “traffic_logs” table containing terminal identifiers, application types, transmitted bytes, and quality metrics.

The server uses a data processing framework such as a numerical computation library and a table manipulation library to aggregate and statistically process the position information and the communication history information. The server maps coordinates to area identifiers or cell identifiers using a spatial index. The server computes, for each time period and each area, aggregated statistics such as total traffic volume, number of active terminals, and average latency. The server thus generates demand prediction features, including time-of-day indicators, day-of-week indicators, holiday indicators, and spatial density measures.

The server constructs demand prediction information by applying a trained neural network model to the demand prediction features. In one embodiment, the server uses a recurrent neural network or a temporal convolutional network that receives sequences of area-wise traffic features over a fixed historical window, such as the previous 24 hours divided into 15-minute slots. The model may include an embedding layer for area identifiers, multiple hidden layers with nonlinear activation functions, and an output layer that predicts future traffic volume for each area and for each future time period. The server trains the model offline by minimizing a loss function such as mean squared error between predicted and actual traffic volumes, using historical data and a gradient-based optimization algorithm. During operation, the server executes inference only, without retraining, on the incoming data.

The server stores the predicted demand values as demand prediction information, indexed by area identifiers and future time periods. Because the server uses a neural network architecture that explicitly models temporal dependencies and spatial correlations, the server achieves more accurate demand predictions than traditional static thresholding or simple moving-average methods. This improved accuracy allows the server to allocate communication resources more precisely and thus reduces both congestion and unnecessary over-provisioning.

The server further generates a prompt sentence based on the demand prediction information and network resource constraint information. The server formats the demand prediction information into a natural language or structured text description that summarizes predicted traffic changes per area and per time range, and appends explicit constraints such as maximum available backhaul bandwidth or per-device capacity limits. For example, the server generates a prompt sentence such as:

“Using the following demand forecast, propose an optimal network configuration for the next 2 hours. Demand forecast: Area A +50% traffic from 18:00 to 20:00, Area B +20% traffic from 18:00 to 19:00, Area C −30% traffic from 18:00 to 22:00. Respect a total backhaul bandwidth limit of 2 Gbps. Output per-area bandwidth allocations, quality of service priorities, and routing parameters.”

The server inputs this prompt sentence into a generative AI model. In one embodiment, the generative AI model is a large language model implemented as a multi-layer transformer neural network, trained on a corpus of configuration documents, network engineering rules, and synthetic network scenarios. The model processes the prompt sentence by encoding the text into token embeddings, applying multiple attention layers that learn relationships between demand levels, constraints, and configuration targets, and decoding a text sequence representing a network setting plan. Because the generative AI model uses attention mechanisms and has been trained to learn non-obvious correlations between traffic patterns and configuration strategies, the server obtains configuration plans that capture complex interactions across areas and time, which are difficult to encode in handcrafted rule systems.

The server parses the output text from the generative AI model into a machine-readable network setting plan. The plan specifies, for each area and time period, parameters such as target bandwidth allocation, quality control conditions, and route control conditions. The server validates the plan against low-level resource limits, and then converts the plan into device-specific configuration commands. The server communicates with communication devices such as base stations, gateways, and routing devices through management interfaces, including command-line interfaces, network configuration protocols, or application programming interfaces.

The server sends configuration commands to update scheduler weights, admission control thresholds, quality of service policies, and routing metrics in the communication devices. The server thus directly controls hardware behavior, including radio resource scheduling and packet forwarding. Because the server uses the generative AI model to synthesize configurations from global demand prediction information and constraints, the server can quickly adapt the network to highly variable conditions while reducing computational overhead compared to exhaustive search-based optimization. The resulting network behavior improves throughput and latency for many users and reduces signaling overhead by proactively reducing congestion events.

In another embodiment, the server monitors performance information and operation information of the communication devices using monitoring measurement mechanisms and monitoring programs. The server periodically collects metrics such as processor utilization, memory usage, interface error counts, and connectivity status. The server stores these metrics as time-stamped entries in monitoring data structures and executes anomaly detection processing. For example, the server applies multivariate threshold checks and unsupervised clustering-based outlier detection to identify patterns indicating potential failure events. The server flags a device as faulty when multiple metrics simultaneously deviate from their learned normal ranges.

The server automatically initiates a repair process for a communication device when a failure event is detected. The server uses a configuration management program to perform remote operations such as restarting services, rebooting devices, and reapplying configuration files. The server may maintain a library of repair scripts tailored to device types and fault classes. In one embodiment, the server generates a prompt sentence that describes the failure status information, such as:

“A base station is unreachable for 3 consecutive monitoring cycles, processor utilization exceeded 95% for 10 minutes prior to failure, and packet loss exceeded 10%. Available repair actions: restart process, full reboot, reapply configuration, reroute traffic. Propose an ordered sequence of repair actions.”

The server inputs this prompt sentence to the generative AI model and obtains a repair procedure.

The server then controls an automatic repair module according to the procedure, executing specific repair actions in the suggested order. Because the generative AI model learns from historical incident-resolution pairs and network topologies, the server can dynamically adapt repair strategies to the current context, reducing mean time to recovery as compared with fixed, manually defined escalation rules.

The terminal also acquires appearance information and voice information of the user from the image acquisition device and the voice acquisition device. The terminal may perform initial preprocessing, such as face detection and audio normalization, and transmit the preprocessed data to the server. The server stores and processes the appearance information and the voice information for emotion recognition. In one embodiment, the server uses a convolutional neural network to analyze facial images and a recurrent neural network to analyze voice features such as pitch, energy, and spectral characteristics. The server fuses the outputs of these neural networks in a joint classification layer to specify an emotional state of the user, such as stress, frustration, or satisfaction.

The server maintains communication quality information, such as throughput, latency, jitter, and packet loss for each user session. The server correlates the emotional state and the communication quality information to determine whether a degraded emotional state is likely associated with poor communication performance. When the server detects such a correlation, the server adjusts the communication quality for that user by dynamically changing at least one of a communication path and a bandwidth allocation. For example, the server may increase the priority of the user's traffic in the quality of service scheduler, allocate additional bandwidth on a radio interface, or select an alternative route with lower latency.

The server further generates a prompt sentence that includes the demand prediction information and the emotional state, and optionally the communication quality information, to obtain an emotion-aware network setting plan. For example, the server generates a prompt sentence such as:

“Current session: 4K video streaming. KPIs: throughput 8 Mbps, latency 80 ms, packet loss 2%. User emotion: frustration detected from facial expression and voice. Predict near-term network demand for this cell is +30% for the next 30 minutes. Propose specific network configuration changes to reduce perceived frustration, including bandwidth, quality of service, and buffer settings. Return configuration parameters.”

The server inputs this prompt sentence into the generative AI model. The generative AI model evaluates the combined demand and emotion context and returns a configuration plan that may, for example, increase bandwidth for the user during peak minutes, adjust packet scheduling priorities, and reduce buffering thresholds. The server implements this plan through the same configuration pathways described above. This integration of emotion signals into the network control loop enables the system to optimize user-perceived quality in ways that conventional throughput-only control loops cannot achieve.

The server also generates notification data that describe the occurrence of a failure event or a repair result, and transmits the notification data to the terminal using a notification delivery mechanism, such as a push notification service. The user receives and views these notifications via a management application on the terminal. The user may then issue a remote operation instruction from the terminal, such as a command to re-execute a repair sequence or to manually adjust allocation in a specific area. The terminal packages this instruction as a structured request and sends it to the server. The server authenticates and authorizes the instruction, and then executes corresponding configuration changes or repair actions. This interactive capability provides an additional safeguard, but the primary automated operations remain carried out by the server.

In several variations, the generative AI model may be deployed locally on the server or remotely as a service. The model architecture may include different numbers of layers, attention heads, embedding sizes, and output formats. The server may constrain the generative AI model to output a machine-readable structure by specifying in the prompt sentence that the output should adopt a particular syntax, such as a key-value listing of parameters. The server may implement additional parsing logic to enforce that only permitted ranges of configuration values are accepted.

The described system improves computer technology in multiple ways. By integrating a temporal-spatial demand prediction model with a generative AI model, the server reduces the need for manual configuration and simplistic rule-based control. The demand prediction model improves the accuracy of traffic forecasting, which reduces wasted bandwidth and limits congestion. The generative AI model allows the server to transform complex state representations, including demand, constraints, device health, and emotion, into executable configuration plans in a single pass, thereby reducing computation time as compared with iterative combinatorial optimization. The anomaly detection and automatic repair mechanisms reduce the need for human intervention and decrease recovery time by selecting repair sequences adapted to the specific failure context.

In addition, the emotion recognition and emotion-aware optimization mechanisms extend the control loop beyond purely technical metrics. The server uses structured data flows, specific neural network architectures, and explicit mapping from emotion labels to control actions. As a result, the system does not merely automate human decision-making but adds a layer of technical reasoning that is not feasible for human operators to perform in real time at scale. The improved resource allocation, quicker failure recovery, and better alignment between network behavior and user state are direct technical effects that arise from the described data structures, algorithms, and hardware control mechanisms.

In alternative embodiments, the server may use different machine learning architectures for demand prediction and emotion recognition, such as graph neural networks to capture relationships among adjacent cells, or transformer-based encoders for multimodal emotion features. The server may maintain different data schemas for storing position information, communication history information, and monitoring metrics, as long as the schemas permit mapping into the feature sets described herein. The control plane integration with communication devices may use different management protocols or interface abstraction layers.

In all of these embodiments, the core structure remains that the server collects measured real-world data from terminals and communication devices, processes such data with specifically configured machine learning models and generative AI models using prompt sentences that encode technical state and constraints, and applies the resulting network setting plans and repair procedures to actual hardware in order to achieve improved technical performance in communication networks.

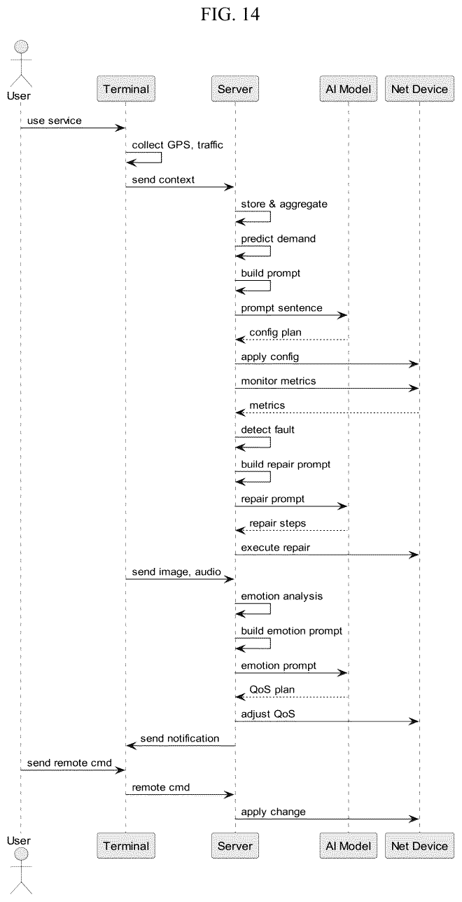

The following describes the processing flow using FIG. 14.

### Step 1

Terminal collects local context data.

Terminal acquires raw GPS signals from a positioning device and converts them into position information including latitude, longitude, and timestamp.

Input: satellite signals and clock information.

Output: structured position records (latitude, longitude, timestamp).

Terminal reads communication history information from a network stack interface, including transmitted bytes, received bytes, application identifiers, and session durations.

Input: protocol counters and socket statistics.

Output: communication history records associated with the current timestamp and application.

Terminal optionally collects sensor data such as signal strength, accelerometer values, and battery level.

Terminal performs simple preprocessing such as unit normalization and noise filtering, then stores the resulting records in a local buffer for transmission.

### Step 2

Terminal transmits context data to the server.

Terminal packages recent position information, communication history information, and optional sensor readings into a message structure.

Input: buffered records from Step 1.

Output: an encoded and encrypted uplink message.

Terminal compresses the message if its size exceeds a threshold, encrypts the payload using a transport security protocol, and sends the message via a wireless communication interface to the server's endpoint.

Terminal records a transmission status code and, in case of failure, schedules a retry with backoff.

### Step 3

Server receives and stores context data.

Server terminates the secure transport session and validates authentication tokens contained in the incoming message.

Input: encrypted uplink message from the terminal.

Output: authenticated and decoded data records.

Server parses the message into position information, communication history information, and sensor readings, then inserts these records into storage structures such as tables indexed by terminal identifier, area identifier, and time interval.

Server updates rolling aggregates, such as total traffic per area in the last 15 minutes, as part of the insertion process.

### Step 4

Server aggregates data and constructs demand prediction features.

Server queries recent historical data for each area and time window and consolidates them into feature vectors.

Input: stored position records and communication history records over a defined historical window.

Output: numerical feature tensors, one per area and time slot.

Server maps each position to an area identifier using a spatial mapping function, groups records by area and time bucket, and computes statistics such as mean traffic volume, number of active terminals, and variance of throughput.

Server appends temporal features (time of day, day of week, holiday indicator) and resource features (current capacity, configured bandwidth) to each feature vector.

### Step 5

Server predicts network demand using a trained neural network.

Server loads a demand prediction model, such as a recurrent neural network or temporal convolutional network, into memory and places it into inference mode.

Input: feature tensors from Step 4.

Output: demand prediction information for future time periods and areas.

Server feeds each sequence of feature vectors per area into the model, which performs a series of matrix multiplications and nonlinear transformations to estimate future traffic volumes and expected active session counts.

Server applies postprocessing, such as clipping negative predictions and rounding to appropriate units, and stores the results as demand prediction information indexed by area and time.

### Step 6

Server generates a prompt sentence for configuration planning.

Server formats the demand prediction information into a human-readable summary and combines it with network resource constraint information such as maximum total bandwidth and per-device limits.

Input: demand prediction information and network resource constraint information.

Output: a prompt sentence describing the forecast and constraints.

Server constructs a structured text, for example:

“Using the following demand forecast, propose an optimal network configuration for the next 2 hours. Demand forecast: Area A +50% traffic from 18:00 to 20:00, Area B +20% traffic from 18:00 to 19:00, Area C −30% traffic from 18:00 to 22:00. Respect a total backhaul bandwidth limit of 2 Gbps. Output per-area bandwidth allocations, quality of service priorities, and routing parameters.”

Server logs the prompt sentence for traceability.

### Step 7

Server obtains a network setting plan from a generative AI model.

Server sends the prompt sentence to a generative AI model implemented as a multi-layer transformer and waits for a text response.

Input: prompt sentence from Step 6.

Output: textual description of a network setting plan.

Server receives the generated text, which may specify, per area and time period, recommended bandwidth allocations, quality control conditions, and route control conditions.

Server parses the text using a text parser or pattern matching, extracting numerical values and configuration keys into an internal data structure.

### Step 8

Server validates and refines the network setting plan.

Server checks whether each suggested parameter lies within allowed ranges and whether global constraints, such as total bandwidth limits, are satisfied.

Input: parsed network setting plan from Step 7 and stored constraint definitions.

Output: validated and possibly adjusted network setting plan.

Server adjusts or discards any parameter that violates hard constraints, recalculating dependent parameters if necessary to maintain consistency.

Server then generates device-specific configuration objects that map high-level settings to individual communication devices and interfaces.

### Step 9

Server applies configuration to communication devices.

Server connects to each relevant communication device via its management interface and transmits configuration commands.

Input: device-specific configuration objects from Step 8.

Output: updated operation settings on communication devices and status responses.

Server uses protocols such as configuration interfaces or command interfaces to set bandwidth profiles, quality of service rules, and routing metrics.

Server records success or failure codes returned by the devices, updates a configuration history log, and may retry failed operations according to a policy.

### Step 10

Server monitors communication devices and detects anomalies.

Server periodically collects performance information and operation information from each communication device using monitoring measurement mechanisms and monitoring programs.

Input: raw monitoring metrics such as processor utilization, memory usage, error counters, latency, and reachability indicators.

Output: labeled monitoring records and anomaly flags.

Server writes the metrics into a monitoring database and evaluates them against threshold rules and anomaly detection models.

Server issues an anomaly flag when a combination of metrics satisfies conditions indicative of a failure event, such as persistent unreachability, high error rates, or unstable resource usage.

### Step 11

Server generates a repair prompt sentence.

Server compiles current failure status information for a device, including recent monitoring metrics and the set of available repair actions, into a textual description.

Input: anomaly flags and associated monitoring metrics from Step 10.

Output: a repair-oriented prompt sentence.

Server constructs a prompt sentence such as:

“A base station is unreachable for 3 consecutive monitoring cycles, processor utilization exceeded 95% for 10 minutes prior to failure, and packet loss exceeded 10%. Available repair actions: restart process, full reboot, reapply configuration, reroute traffic. Propose an ordered sequence of repair actions.”

Server prepares this text as an input to the generative AI model.

### Step 12

Server obtains and executes a repair procedure.

Server submits the repair prompt sentence to the generative AI model and receives a recommended repair procedure.

Input: repair prompt sentence from Step 11.

Output: ordered list of repair actions with optional conditions.

Server parses the model output into a structured sequence, such as “restart process,” “if still unreachable then reboot,” “if still faulty then reapply configuration,” and “if congestion persists then reroute traffic.”

Server invokes an automatic repair module that issues remote commands to the affected communication device according to the sequence, monitors the outcome after each action, and stops when normal operation is restored or all actions are exhausted.

### Step 13

Server acquires user appearance and voice information.

Terminal captures images and audio segments from the image acquisition device and the voice acquisition device while the user uses a communication service, and transmits them to the server.

Input: raw or preprocessed image frames and audio samples from the terminal.

Output: received appearance information and voice information stored on the server.

Server associates each media sample with a user identifier, session identifier, and timestamp, and writes the samples or extracted features to an emotion analysis data store.

### Step 14

Server computes user emotional state.

Server applies an emotion recognition model to the stored appearance information and voice information.

Input: facial image features and voice features derived from Step 13.

Output: emotional state labels and confidence scores.

Server runs a convolutional network on image features to produce probabilities for facial expressions, and a recurrent or temporal model on audio features to produce probabilities for vocal affect.

Server fuses these outputs in a decision layer, selects the most likely emotional state, and records the label and score in association with the user session.

### Step 15

Server correlates emotional state with communication quality.

Server retrieves current communication quality information for the user, such as throughput, latency, and packet loss, and compares it to target ranges.

Input: emotional state labels from Step 14 and communication quality metrics from network monitoring modules.

Output: correlation assessments and control triggers.

Server evaluates whether negative emotional states, such as frustration or stress, co-occur with degraded quality metrics beyond configured thresholds.

Server raises a control trigger when such a correlation pattern is detected.

### Step 16

Server generates an emotion-aware prompt sentence.

Server summarizes the user's emotional state, current quality metrics, and near-term demand prediction for the user's area into a descriptive text.

Input: emotional state, communication quality information, and local demand prediction information.

Output: an emotion-aware prompt sentence.

Server constructs a prompt sentence, for example:

“Current session: 4K video streaming. KPIs: throughput 8 Mbps, latency 80 ms, packet loss 2%. User emotion: frustration detected from facial expression and voice. Predict near-term network demand for this cell is +30% for the next 30 minutes. Propose specific network configuration changes to reduce perceived frustration, including bandwidth, quality of service, and buffer settings. Return configuration parameters.”

Server prepares this prompt sentence as input to the generative AI model.

### Step 17

Server obtains an emotion-aware network setting plan and applies it.

Server sends the emotion-aware prompt sentence to the generative AI model and receives a configuration proposal.

Input: prompt sentence from Step 16.

Output: refined network setting plan tailored to the emotional state.

Server parses the proposed parameters, such as increased bandwidth, elevated quality of service priority, and adjusted buffering thresholds, into device-specific commands.

Server applies these commands to the relevant base stations and routing devices handling the user's traffic, and updates internal records so that subsequent monitoring can verify the effect on both quality metrics and emotional state.

### Step 18

Server notifies user and processes remote operation instructions.

Server generates notification data describing key events, such as detection of a failure event or completion of a repair procedure, and sends this data via a notification delivery mechanism to the terminal.

Input: event information from monitoring and repair modules.

Output: user-visible notifications.

User views the notifications on the terminal and may initiate a remote operation instruction, such as a manual restart request or a request for additional bandwidth in a selected area.

Terminal sends the instruction to the server, and the server authenticates and authorizes the request, maps it to configuration operations, and executes the requested changes, updating both configuration and monitoring records accordingly.

The data generation model 58 is a so-called generative artificial intelligence (AI).

Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent.

Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

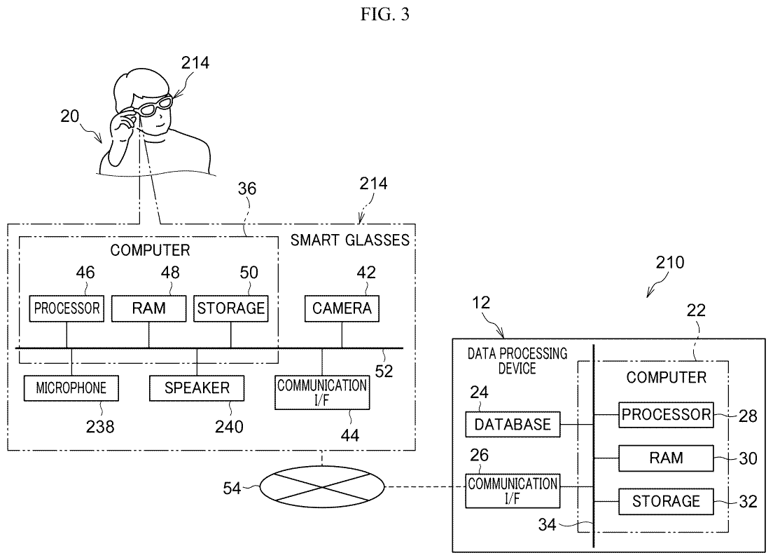

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

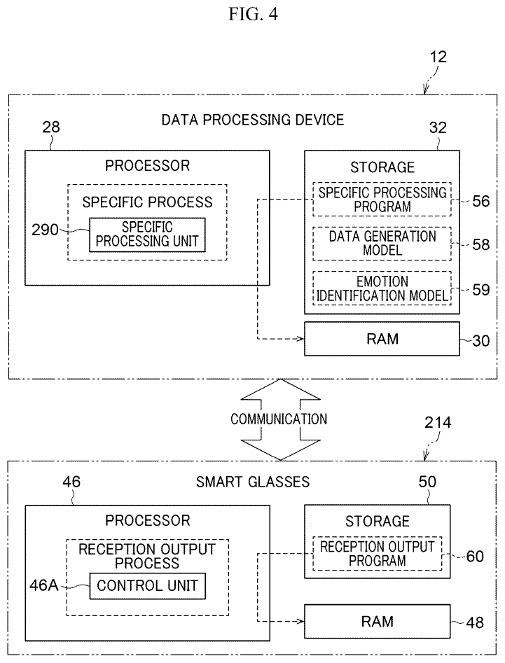

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc.

The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

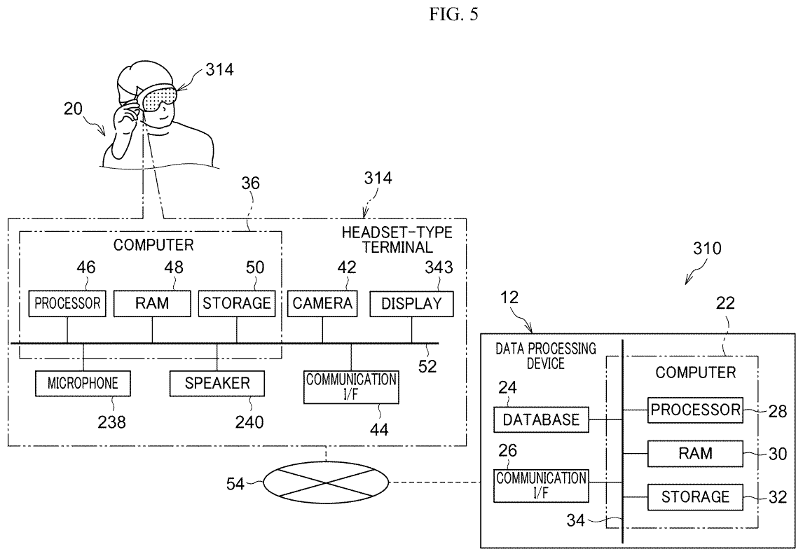

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

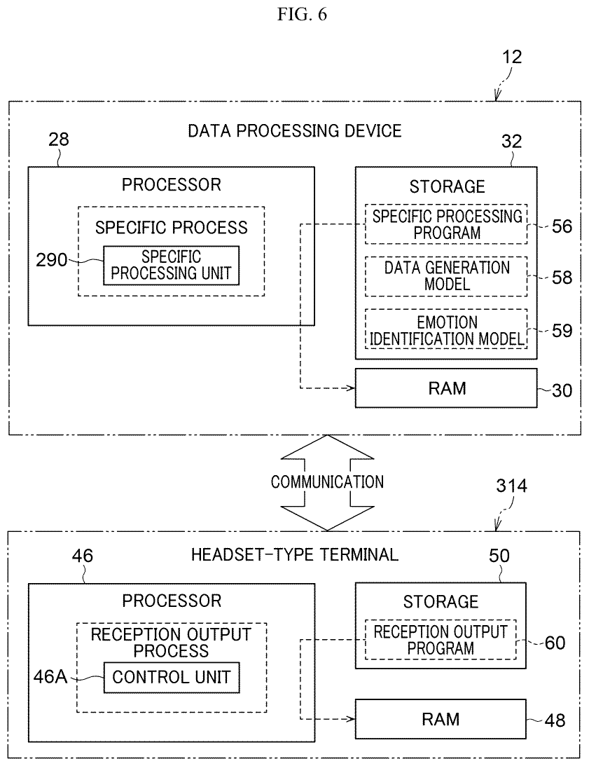

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

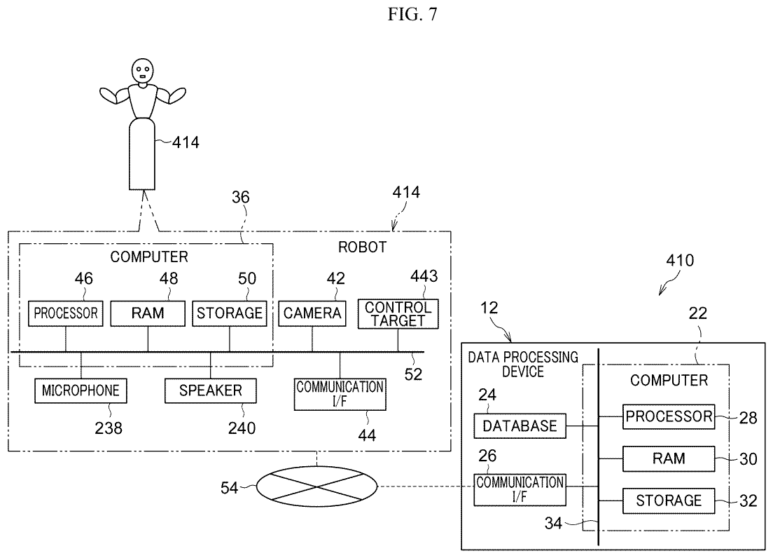

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

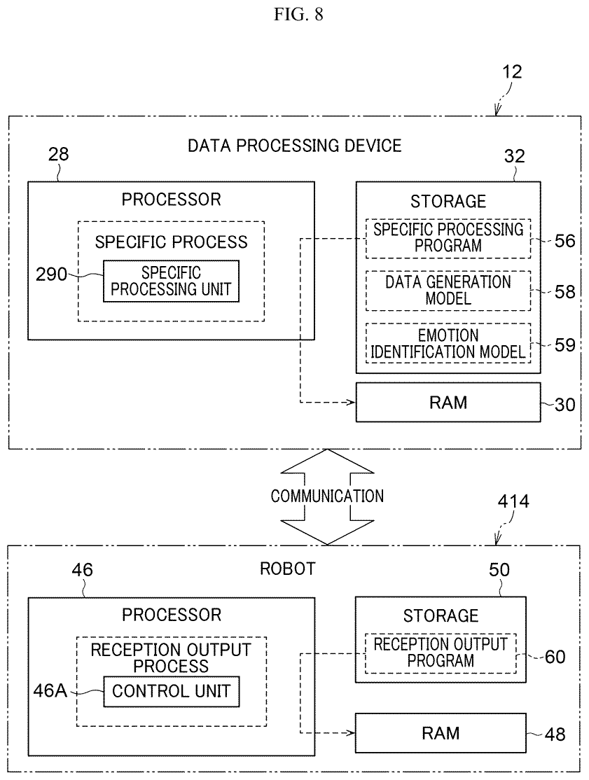

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent.

Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

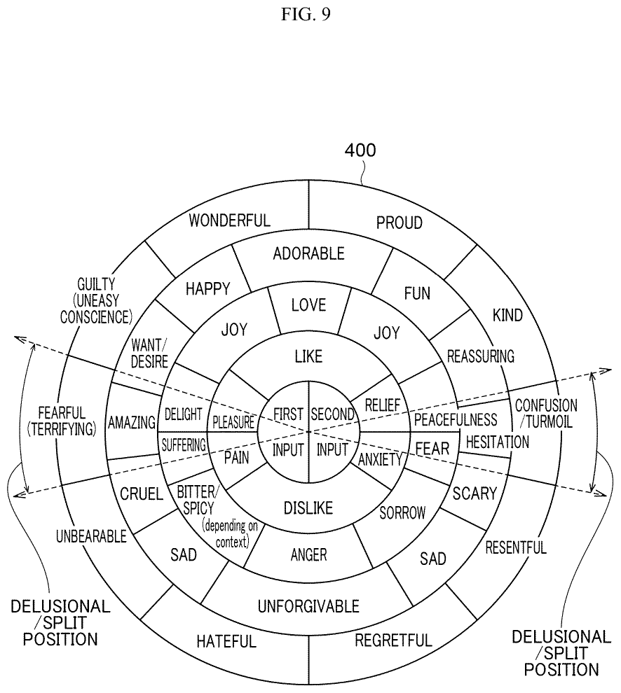

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

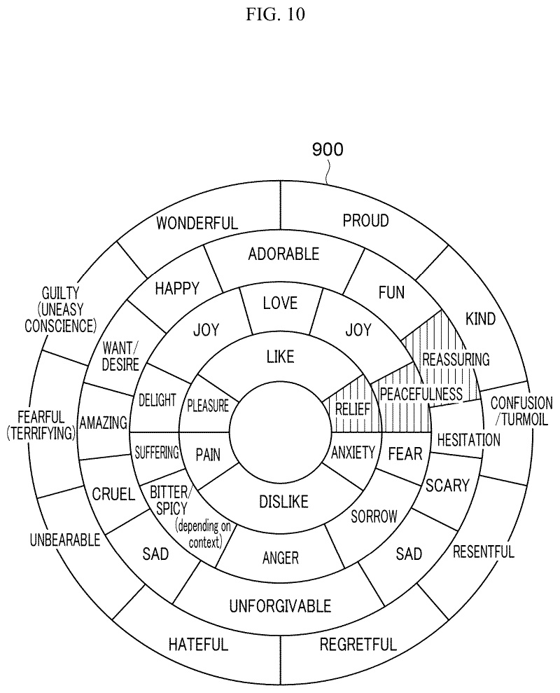

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive position information of mobile bodies from an information acquisition apparatus, aggregate the position information based on time information and area information, and generate distribution information of the mobile bodies for each predetermined time interval and spatial unit,
obtain, from a storage apparatus, the distribution information of the mobile bodies and historical communication amount information and performance information of communication apparatuses constituting a communication network, associate the distribution information with the communication amount information and the performance information to generate demand prediction data, and calculate demand prediction results of the communication network for predetermined times and areas based on the demand prediction data,
generate a prompt sentence to be input to a generative artificial intelligence model by using the demand prediction results of the communication network and event information related to a time range and an area range for which the demand prediction results are calculated, input the prompt sentence and the demand prediction data into the generative artificial intelligence model, and cause the generative artificial intelligence model to output a configuration plan including optimal setting contents of the communication network for each time and each area,
generate setting information for the communication apparatuses based on the configuration plan output from the generative artificial intelligence model, transmit the setting information to the communication apparatuses via a communication management apparatus, and automatically change parameters of the communication network to execute resource allocation and quality control,
analyze operation state information of the communication apparatuses acquired from detection apparatuses and monitoring programs provided in the communication apparatuses, upon detecting an abnormality of at least one of the communication apparatuses, input into the generative artificial intelligence model a prompt sentence including contents of the abnormality and configuration information of the communication apparatuses to obtain a repair procedure plan, and start an automatic repair processing program to automatically execute a repair process including at least one of setting change of the communication apparatuses, restart processing, and route switching processing based on the repair procedure plan, and
integrate the demand prediction results, the configuration plan, and an execution status of the repair process, transmit notification information including the integration to a network management terminal, and record the integration as learning data for updating future demand prediction and contents of the prompt sentence.

### Supplementary 2

The system according to supplementary 1,
wherein the processor is configured to cause the generative artificial intelligence model to receive, as inputs, the prompt sentence and the demand prediction data, and, based on demand prediction errors of the communication network and evaluation information of past configuration results, sequentially update constituent elements and weighting of the prompt sentence so as to improve accuracy of the configuration plan of the communication network for each time and each area.

### Supplementary 3

The system according to supplementary 1,
wherein the processor is configured to compare the demand prediction results of the communication network with the configuration plan output from the generative artificial intelligence model, when a time period and an area in which a demand excess exceeding a predetermined threshold is expected are identified, generate an additional prompt sentence in which information relating to the time period and the area is emphasized, re-input the additional prompt sentence into the generative artificial intelligence model to obtain a corrected network configuration plan for the time period and the area, and apply the corrected network configuration plan to the communication apparatuses.

### Application Example 1

### Supplementary 1

A system comprising a processor,
wherein the processor is configured to acquire position information from a mobile device and store the position information in association with time information,
obtain the stored position information and past traffic information related to a communication apparatus, and generate a demand prediction result that estimates future communication demand for predetermined time intervals and predetermined spatial units based on the position information and the traffic information,
convert the demand prediction result and network configuration conditions into a prompt sentence as input data for a generative AI model, input the prompt sentence into the generative AI model, and cause the generative AI model to generate network configuration information including communication resource allocation information and quality control information for each of the time intervals and the spatial units,
set control parameters including bandwidth allocation, priority control, and handover conditions for a communication control apparatus or a base station apparatus based on the network configuration information, and automatically change operation of the communication control apparatus or the base station apparatus,
transmit, to a terminal device, policy information relating to communication control on a terminal side included in the network configuration information, and cause the terminal device to perform transmission control and reception control for each application type, bandwidth limitation, and adjustment of reporting intervals,
acquire operation state information and failure sign information of the base station apparatus via a sensor apparatus or monitoring software, generate a prompt sentence for the generative AI model based on the operation state information, input the prompt sentence into the generative AI model to obtain a failure occurrence probability and a bypass configuration plan, and when the failure occurrence probability exceeds a predetermined threshold, activate an automatic recovery module that performs switching of a communication route to another base station apparatus or redistribution of communication resources based on the bypass configuration plan, and acquire communication state information and application-specific traffic information from a terminal device mounted on an autonomous mobile body, and perform feedback processing that updates the demand prediction result and the network configuration information so as to reduce delay and avoid disconnection for communications related to the autonomous mobile body.

### Supplementary 2

The system according to supplementary 1,
wherein the processor is configured to cause the generative AI model to generate the network configuration information by receiving, as input, the prompt sentence including the demand prediction result and the network configuration conditions, the network configuration information including, for each of the time intervals and the spatial units, a temporal transition of communication demand, a congestion occurrence probability, and an alternative network configuration plan in a case where congestion occurs.

### Supplementary 3

The system according to supplementary 1,
wherein the processor is configured to cause the automatic recovery module, based on the failure occurrence probability and the bypass configuration plan output from the generative AI model, to perform, before stoppage of the base station apparatus, advance distribution of communication load to an adjacent base station apparatus, resetting of a communication path, and change of quality control parameters.

### Example 2

### Supplementary 1

A system comprising a processor,
wherein the processor is configured to
acquire terminal information including position information and communication history information from a communication apparatus, acquire traffic information and apparatus state information from a network monitoring apparatus, and integrate the terminal information, the traffic information, and the apparatus state information to generate basic data for demand estimation for each time and each area,
execute demand prediction processing by a machine learning algorithm using the basic data for demand estimation to generate a demand prediction result representing future communication demand for each time and each area,
calculate, on the basis of the demand prediction result and network configuration information, candidate network settings including bandwidth allocation for each communication path, quality control parameters, and priority settings by mathematical optimization or reinforcement learning,
generate a prompt sentence including the demand prediction result and the candidate network settings, input the prompt sentence into a generative artificial intelligence model, and analyze a response obtained from the generative artificial intelligence model, the response being in a natural language format or a structured data format, to convert the response into setting information and control command sequences applicable to the communication apparatus,
apply the network settings to a plurality of communication apparatuses by using the setting information and the control command sequences through a remote operation communication protocol, acquire apparatus state information after the application, and verify consistency between the apparatus state information and the applied network settings,
monitor operation states of base stations and relay apparatuses on a continuous basis by using the traffic information and the apparatus state information, identify failure candidates by anomaly detection processing using statistical methods or machine learning, and execute an automatic recovery process including at least one of switching a communication path, restarting an interface, and rolling back a setting in accordance with an identified failure candidate, and
evaluate deviation between the automatically applied network settings and results of the automatic recovery process on one hand and the demand prediction result on the other hand, and store an evaluation result as learning data for the machine learning algorithm and the generative artificial intelligence model so as to improve accuracy of future demand prediction and network setting proposals.

### Supplementary 2

The system according to supplementary 1,
wherein the processor is configured to cause the generative artificial intelligence model, on the basis of the demand prediction result and the network configuration information input as the prompt sentence, to generate, in a natural language format or a structured data format, a network setting plan including at least a bandwidth allocation policy for each time and each area, quality control parameters, failure-time switchover procedures, and control command sequences for implementing the bandwidth allocation policy, the quality control parameters, and the failure-time switchover procedures, and to extract, from the network setting plan, only portions that conform to safety verification rules and apply the extracted portions to the communication apparatus.

### Supplementary 3

The system according to supplementary 1,
wherein the processor is configured to periodically retrain the machine learning algorithm for the demand prediction processing and the generative artificial intelligence model by using the position information and usage state information transmitted from terminals and actual measured communication demand information acquired from the network monitoring apparatus, and to automatically update the network settings in accordance with demand fluctuations caused by changes in user behavior and occurrence of events.

### Application Example 2

### Supplementary 1

A system comprising a processor,
wherein the processor is configured to
collect position information acquired by a positioning device of a mobile terminal together with communication history information, aggregate and statistically process the position information and the communication history information, and generate demand prediction information indicating communication demand for each time period and each area,
generate a prompt sentence as text data including the demand prediction information and network resource constraint information, input the prompt sentence to a generative AI model, obtain a network setting plan including, for each of the time period and the area, at least one of bandwidth allocation, quality control condition, and route control condition, and automatically update operation settings of communication equipment based on the network setting plan,
continuously accumulate performance information and operation information of the communication equipment acquired from monitoring measurement apparatuses and monitoring programs, execute threshold determination or anomaly detection processing on the performance information and the operation information to detect a failure event, and automatically execute a repair process including at least one of a restart process and a configuration reapplication process on the communication equipment for which the failure event is detected, by remote operation using a configuration management program,
acquire appearance information and voice information of a user from an image acquisition device and a voice acquisition device, input the appearance information and the voice information to an emotion recognition model to specify an emotional state of the user, and adjust communication quality by dynamically changing at least one of a communication path and a bandwidth allocation for the user based on the emotional state and communication quality information,
generate, as a prompt sentence, state information including at least the demand prediction information and the emotional state, input the prompt sentence to a generative AI model, obtain, from the generative AI model, a network setting plan and a service provision policy that take the emotional state into account, and perform communication control and service provision in accordance with the network setting plan and the service provision policy, and
generate notification data including state information relating to occurrence of the failure event or a repair result, transmit the notification data to the mobile terminal via a notification delivery mechanism, and execute at least one of the restart process and a network setting change process for the communication equipment based on a remote operation instruction received from the mobile terminal.

### Supplementary 2

The system according to supplementary 1,
wherein the processor is configured to
generate, as a prompt sentence, state information including at least the demand prediction information and the communication quality information, input the prompt sentence to a generative AI model, obtain, from the generative AI model, a control plan including optimal network settings corresponding to time and place and a communication quality adjustment policy corresponding to the emotional state of the user, and automatically execute a setting change process of the communication equipment based on the control plan.

### Supplementary 3

The system according to supplementary 1,
wherein the processor is configured to
input, to a generative AI model, a prompt sentence including at least failure status information of a base station and information on available repair means acquired from the monitoring measurement apparatuses and the monitoring programs, obtain, from the generative AI model, a repair procedure, control an automatic repair module according to the repair procedure, and automatically execute at least one of the restart process, a setting change process, and a bypass route setting process for the base station.

What is claimed is:

1. A system comprising:
circuitry configured to:
receive, via a communication interface coupled to a packet-switched network, position data of mobile terminals from an information acquisition apparatus, aggregate the position data based on time intervals and spatial units to generate distribution data;
obtain, from a storage device, the distribution data together with historical communication volume data and performance data of communication apparatuses constituting a communication network, associate the distribution data with the communication volume data and the performance data to generate demand prediction data, and compute demand prediction results for predetermined times and areas;
construct a prompt data structure comprising the demand prediction results and event data associated with a time range and an area range, and transmit the prompt data structure together with the demand prediction data to a generative neural network model to cause the generative neural network model to output a configuration plan comprising setting parameters for the communication network for each time and each area;
generate setting data for the communication apparatuses based on the configuration plan, and transmit the setting data to the communication apparatuses via a communication management apparatus to change parameters of the communication network for resource allocation and quality control;
analyze operation state data of the communication apparatuses acquired from detection apparatuses and monitoring programs, upon detecting an abnormality of at least one communication apparatus, construct a repair prompt data structure comprising abnormality data and configuration data of the communication apparatuses, transmit the repair prompt data structure to the generative neural network model to obtain a repair procedure plan, and execute an automatic repair process comprising at least one of a setting change, a restart process, and a route switching process based on the repair procedure plan; and
store the demand prediction results, the configuration plan, and an execution status of the repair process as learning data in the storage device, and update at least one of the prompt data structure and the demand prediction data based on the learning data.

2. The system according to claim 1,
wherein the circuitry is further configured to cause the generative neural network model to receive the prompt data structure and the demand prediction data, and, based on demand prediction errors and evaluation data of past configuration results, sequentially update constituent elements and weighting of the prompt data structure to improve accuracy of subsequent configuration plans.

3. The system according to claim 2,
wherein the circuitry is further configured to compare the demand prediction results with the configuration plan, identify a time period and an area in which demand excess exceeding a predetermined threshold is expected, generate a supplemental prompt data structure emphasizing data relating to the identified time period and area, re-transmit the supplemental prompt data structure to the generative neural network model to obtain a corrected configuration plan, and apply the corrected configuration plan to the communication apparatuses.

4. The system according to claim 1,
wherein the circuitry is further configured to set control parameters comprising bandwidth allocation, priority control, and handover conditions for the communication apparatuses based on the configuration plan, and transmit, to a terminal device, policy data relating to communication control on a terminal side, the policy data causing the terminal device to perform transmission control and reception control for each application type and adjustment of reporting intervals.

5. The system according to claim 4,
wherein the circuitry is further configured to acquire operation state data and failure sign data of a base station apparatus via a sensor apparatus, generate a failure prompt data structure based on the operation state data, transmit the failure prompt data structure to the generative neural network model to obtain a failure occurrence probability and a bypass configuration plan, and when the failure occurrence probability exceeds a threshold, activate a recovery module that performs switching of a communication route to another base station apparatus or redistribution of communication resources based on the bypass configuration plan.

6. The system according to claim 5,
wherein the recovery module is further configured to, based on the failure occurrence probability and the bypass configuration plan, perform advance distribution of communication load to an adjacent base station apparatus, resetting of a communication path, and change of quality control parameters prior to stoppage of the base station apparatus.

7. The system according to claim 4,
wherein the circuitry is further configured to acquire communication state data and application-specific traffic data from a terminal device associated with an autonomous mobile body, and perform feedback processing that updates the demand prediction results and the configuration plan to reduce delay and avoid disconnection for communications associated with the autonomous mobile body.

8. The system according to claim 1,
wherein the circuitry is further configured to execute demand prediction processing by a machine learning model using the demand prediction data to generate the demand prediction results, and calculate candidate network settings comprising bandwidth allocation for each communication path, quality control parameters, and priority settings by at least one of mathematical optimization and reinforcement learning based on the demand prediction results and existing network configuration data.

9. The system according to claim 8,
wherein the circuitry is further configured to analyze a response from the generative neural network model, the response being in at least one of a natural language format and a structured data format, and convert the response into setting data and control command sequences applicable to the communication apparatuses.

10. The system according to claim 9,
wherein the circuitry applies network settings to a plurality of communication apparatuses by transmitting the setting data and the control command sequences through a remote operation protocol, acquires apparatus state data after application, and verifies consistency between the apparatus state data and the applied network settings.

11. The system according to claim 8,
wherein the circuitry monitors operation states of base stations and relay apparatuses using the traffic data and apparatus state data, identifies failure candidates by anomaly detection processing using at least one of statistical methods and machine learning, and executes a recovery process comprising at least one of switching a communication path, restarting an interface, and rolling back a setting in accordance with an identified failure candidate.

12. The system according to claim 8,
wherein the circuitry evaluates deviation between the applied network settings and results of the recovery process on one hand and the demand prediction results on the other hand, and stores an evaluation result as learning data for the machine learning model and the generative neural network model.

13. The system according to claim 12,
wherein the circuitry periodically retrains the machine learning model using position data and usage state data received from terminals and actual measured communication demand data acquired from a network monitoring apparatus, and automatically updates network settings in accordance with demand fluctuations caused by changes in user behavior and occurrence of events.

14. The system according to claim 1,
wherein the circuitry is further configured to acquire appearance data and voice data of a user from an image acquisition device and an audio acquisition device, input the appearance data and the voice data to an emotion recognition model to determine an emotional state of the user, and adjust communication quality by dynamically changing at least one of a communication path and a bandwidth allocation for the user based on the emotional state and communication quality data.

15. The system according to claim 14,
wherein the circuitry is further configured to generate state data comprising at least the demand prediction results and the emotional state as a prompt data structure, transmit the prompt data structure to the generative neural network model to obtain a network setting plan and a service provision policy that account for the emotional state, and perform communication control in accordance with the network setting plan and the service provision policy.

16. The system according to claim 14,
wherein the circuitry is further configured to generate notification data comprising state data relating to occurrence of a failure event or a repair result, transmit the notification data to a mobile terminal via a notification delivery mechanism, and execute at least one of a restart process and a network setting change process for a communication apparatus based on a remote operation instruction received from the mobile terminal.

17. The system according to claim 1,
wherein transmitting the setting data to the communication apparatuses comprises generating control command sequences in a format compatible with a remote operation communication protocol, and verifying acknowledgment of receipt from each communication apparatus prior to committing the setting change.

18. A system comprising:
circuitry configured to:
receive position data of mobile terminals via a communication interface coupled to a packet-switched network, and aggregate the position data by time intervals and spatial units to generate distribution data;
associate the distribution data with historical communication volume data and performance data of communication apparatuses to generate demand prediction data, and compute demand prediction results;
construct a prompt data structure comprising the demand prediction results and event data, and transmit the prompt data structure to a generative neural network model to obtain a configuration plan for the communication network;
generate setting data based on the configuration plan and transmit the setting data to the communication apparatuses to change network parameters;
detect an abnormality of at least one communication apparatus from operation state data, construct a repair prompt data structure, transmit the repair prompt data structure to the generative neural network model to obtain a repair procedure plan, and execute an automatic repair process based on the repair procedure plan;
store the demand prediction results, the configuration plan, and repair execution status as learning data; and
update at least one of the prompt data structure and the demand prediction data based on the learning data.

19. The system according to claim 18,
wherein the circuitry is further configured to acquire appearance data and voice data of a user, determine an emotional state by an emotion recognition model, and include the emotional state in the prompt data structure to obtain a network setting plan accounting for the emotional state.

20. A method comprising:
receiving, by circuitry via a communication interface coupled to a packet-switched network, position data of mobile terminals, and aggregating the position data based on time intervals and spatial units to generate distribution data;
associating the distribution data with historical communication volume data and performance data of communication apparatuses to generate demand prediction data, and computing demand prediction results for predetermined times and areas;
constructing a prompt data structure comprising the demand prediction results and event data, and transmitting the prompt data structure to a generative neural network model to obtain a configuration plan comprising setting parameters for the communication network;
generating setting data based on the configuration plan and transmitting the setting data to the communication apparatuses via a communication management apparatus to change parameters for resource allocation and quality control;
analyzing operation state data, upon detecting an abnormality, constructing a repair prompt data structure and transmitting the repair prompt data structure to the generative neural network model to obtain a repair procedure plan, and executing an automatic repair process based on the repair procedure plan; and
storing the demand prediction results, the configuration plan, and repair execution status as learning data, and updating at least one of the prompt data structure and the demand prediction data based on the learning data.
